(19) United States
(12) Patent Application Publication
(10) Pub. No.: US 2023/0316382 A1
(43) Pub. Date: Oct. 5, 2023

(54) METHODS AND SYSTEMS FOR AUTOMATED PERSONALIZATION

(71) Applicant: XGenesis Inc., Clearwater, FL (US)

(72) Inventors: Francis Faricy, Dunedin, FL (US); Jason Robert Clements, Clearwater, FL (US)

(21) Appl. No.: 18/300,927

(22) Filed: Apr. 14, 2023

Related U.S. Application Data
(63) Continuation of application No. PCT/US2021/056450, filed on Oct. 25, 2021.
(60) Provisional application No. 63/106,294, filed on Oct. 27, 2020.

(51) Int. Cl. G06Q 30/0601

(52) U.S. Cl. CPC G06Q 30/0631; G06Q 30/0641

(57) ABSTRACT

The present disclosure provides a system for automating custom personalization for a target website. The system comprises: an artificial intelligence (AI) engine including one or more machine learning algorithm trained models for providing one or more personalization features; a personalization module configured for integrating the one or more personalization features into the target website; and a user interface module configured to provide a graphical user interface (GUI) for a user to modify and manage the one or more personalization features.

### CROSS-REFERENCE

This application is a continuation of International Application No. PCT/US2021/056450, filed Oct. 25, 2021, which claims priority to U.S. Provisional Patent Application No. 63/106,294, filed Oct. 27, 2020, which is entirely incorporated herein by reference.

### BACKGROUND

In the digital age of instant gratification, consumer attention span is gradually getting shorter. The need to provide the perfect experience to each website visitor is stronger. Personalized recommendations and experiences may meet such need. For instance, services, products, information, consumer experiences, or messages can be personalized or tailored to individuals based on information that a company or merchant has gathered about the individual or groups of individuals. For example, different products can be recommended to different consumers when they are shopping on the same website. Personalization has been recognized as one of the most efficient and cost-effective strategies for increasing consumer engagement. However, developing a website to provide personalized services can be expensive or requires specific expertise.

### SUMMARY

Current personalization systems may be expensive, require specific expertise or tedious and time-consuming integration process. For example, current on-site personalization may be designed to enable tracking on-site user behavior, building recommendation groups or predicting a customer's next steps, integrating product or recommended content catalogs, showing the recommendations to consumers via a website, email or other media channels. However, it is costly to build and create a website with the above-mentioned personalization features. In particular, expertise (e.g., website development and design) may be required to build or create such personalization features. Therefore, a need exists for a system or method that can automate personalization rapidly at ease. The present disclosure provides a platform addressing the above needs by automating the personalization process and providing enhanced personalization features thereby improving the performance. The platform may allow users (e.g., merchants, developers, sales manager) to rapidly build website elements to generate personalized recommendations for their consumers. In particular, the website personalization can be performed in an automated manner with journey-aware recommendations in real-time.

The personalization platform may include a fully automated recommendation engine that can provide automated predictions and recommendations without requiring configuration and can be rapidly integrated at ease. The personalization platform may include an advanced ruleset engine to further customize personalization results and consumer interaction as needed.

Additionally, current personalization products may largely focus on building consumer segments (e.g., demographic, geographic, etc.) and using static rulesets to select a set of products to recommend to a consumer segment. Such recommendation may be tailored to a segment or a group of consumers sharing similar traits rather than truly individualized personalization. An artificial intelligence (AI) engine of the personalization platform herein may be capable of generating personalized recommendations that are unique to each consumer by leveraging the knowledge extracted from each unique individual on a website. Additionally, the AI engine of the personalization platform may be capable of accurately predicting what the consumers will engage with in the future. The provided systems and methods may allow for a range of use cases in industries such as online shopping, e-commerce, content creation (report, brochures, digital magazines, product guides, sales playbooks, sales proposals, whitepapers, newsletters, company handbooks, annual reports, etc.), advertisement, restaurants and dining, tourism and entertainment, healthcare, service delivery, and various others that at least part of the services are delivered through a website, media channel or digital product.

In an aspect, a system is provided for automating personalization for a target website. The system comprises: an artificial intelligence (AI) engine including one or more machine learning algorithm trained models for providing one or more personalization features; a personalization module configured for integrating the one or more personalization features into the target website; and a user interface module configured to provide a graphical user interface (GUI) for a user to modify and manage the one or more personalization features.

In some embodiments, at least one of the one or more personalization features is trained for generating recommendations personalized to an individual visitor to the target website. In some embodiments, the personalization module is configured to further deploy a tracker plugin to the target website for tracking user behaviors on the target website. In some embodiments, the personalization module is configured to integrate the one or more personalization features by injecting code into the target website.

In some embodiments, the GUI is configured to receive a user input indicating a placement of the one or more personalization features. In some embodiments, the GUI is configured to receive a user input comprising a selection of an existing element on the target website and a placement of one of the one or more personalization features with respect to the existing element. In some cases, the GUI is configured to display a plurality of placement options for placing the one of the one or more personalization features. In some embodiments, the GUI is configured to receive a user input indicative of a placement of one of the one or more personalization features and setting a hook for the one of the one or more personalization features.

In some embodiments, the GUI is configured to provide a preview of the one or more personalization features prior to publishing the one or more personalization features to the target website. In some cases, the preview is provided by loading the target website and rendering the one or more personalization features on the loaded target website.

In some embodiments, the GUI is configured to receive a user input defining a ruleset for at least one of the one or more personalization features. In some cases, the ruleset is for modifying a result predicted by the at least one of the one or more personalization features. In some embodiments, the GUI is further configured to allow the user to adjust a percent of web traffic for the target website to be analyzed by the AI engine.

In a related yet separate aspect, a method is provided for automating personalization for a target website. The method comprises: generating, with aid of an AI engine, one or more personalization features; integrating the one or more personalization features into the target website; and providing a GUI for a user to modify and manage the one or more personalization features.

In some embodiments, at least one of the one or more personalization features is trained for generating recommendations personalized to an individual visiting the target website. In some embodiments, the method further comprises deploying a tracker plugin to the target website for tracking user behaviors on the target website. In some embodiments, the method further comprises extracting analytics from the tracked user behavior indicating an impact of at least one of the one or more personalization features.

In some embodiments, integrating the one or more personalization features comprises injecting code into the target website.

In some embodiments, the method further comprises receiving, via the GUI, a user input indicating a placement of the one or more personalization features on the target website. In some cases, the user input comprises a selection of an existing element on the target website and a placement of one of the one or more personalization features with respect to the existing element. In some instances, the method further comprises displaying a plurality of placement options within the GUI for placing the one of the one or more personalization features. In some cases, the user input is indicative of a placement of one of the one or more personalization features and setting a hook for the one of the one or more personalization features.

In some embodiments, the method further comprises providing a preview of the one or more personalization features within the GUI prior to publishing the one or more personalization features to the target website. In some cases, providing the preview comprises loading the target website and rendering the one or more personalization features on the loaded target website within the GUI.

In some embodiments, the method further comprising receiving, via the GUI, a user input defining a ruleset for at least one of the one or more personalization features. In some cases, the ruleset is for modifying a result predicted by the at least one of the one or more personalization features.

In some embodiments, the method further comprises controlling the AI engine via the GUI. In some cases, the method further comprises receiving, via the GUI, a user input for adjusting a percent of web traffic for the target website to be analyzed by the AI engine.

Another aspect of the present disclosure provides a non-transitory computer readable medium comprising machine executable code that, upon execution by one or more computer processors, implements any of the methods above or elsewhere herein.

Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “figure” and “FIG.” herein) of which:

FIG. 1 schematically shows a network or personalization platform in which the method and system for automated personalization can be implemented;

FIG. 2 schematically shows a diagram of a personalization system, in accordance with various embodiment of the present disclosure;

FIG. 3 shows an example of signing in or logging into a client portal;

FIG. 4 shows an example of analytics user interface;

FIG. 5 and FIG. 6 show examples of various smart elements that can be integrated into a third-party platform (e.g., e-commerce website);

FIG. 7 shows an example of a product catalog;

FIG. 8 shows an example of a team section of a client portal;

FIG. 9 shows an example of a graphical user interface (GUI) for controlling an AI engine;

FIGS. 10-13 show various examples of creating, editing and managing smart elements via the GUIs;

FIGS. 14-17 show examples of editing smart elements using a drag and drop builder;

FIGS. 18-21 show examples of editing smart elements using a smart editor;

FIGS. 22-26 show examples of a placement tool of a user portal;

FIG. 27 shows an example of previewing the smart elements;

FIGS. 28-34 show examples of various features of Smart Element Markup Language (SEML); and

FIGS. 35-41 show examples of GUI for users to modify and manage the rulesets thereby modifying the AI predictions.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Current on-site personalization may be desired to enable tracking on-site user behavior, building recommendation groups or predicting a customer's next steps, integrating product or recommended content catalogs, showing the recommendations to consumers via a website, email or other media channels. However, it is costly to build and create a website with the above-mentioned personalization features. The present disclosure provides a platform addressing the above needs by automating the personalization process and providing enhanced personalization features thereby improving the performance. The platform may allow users (e.g., merchants, developers, sales manager) to rapidly build website elements to generate recommendations for their consumers. In particular, the website personalization can be performed in an automated manner with journey-aware recommendations in real-time.

The personalization platform may include a fully automated recommendation engine that can provide automated predictions and recommendations without requiring configuration and can be rapidly integrated at ease. The personalization platform may include an advanced ruleset engine to further customize personalization results and consumer interaction as needed.

Additionally, existing personalization products may largely focus on building consumer segments (e.g., demographic, geographic, etc.) and using static rulesets to select a set of products to recommend to a consumer segment. Such recommendation may be tailored to a segment or a group of consumers sharing similar traits rather than truly individualized personalization. An artificial intelligence (AI) engine of the personalization platform may be capable of generating personalized recommendations that are unique to each consumer by leveraging the knowledge extracted from each unique individual on a website. Additionally, the AI engine of the personalization platform may be capable of accurately predicting what the consumers will engage with in the future. The provided systems and methods may allow for a range of use cases in industries such as online shopping, e-commerce, content creation (report, brochures, digital magazines, product guides, sales playbooks, sales proposals, whitepapers, newsletters, company handbooks, annual reports, etc.), advertisement, restaurants and dining, tourism and entertainment, healthcare, service delivery, and various others that at least part of the services are delivered through a website, media channel or digital product.

A user of the provided system may be an individual (e.g., marketing managers, content managers, sales people, recruiters, marketers, website designer, etc.), an entity (e.g., merchant, retailor, business, company, organization, etc.), a group of individuals that may be retailor, website designer or content creators who are customizing and personalizing the website, a customer experience or digital content. A user of the personalization platform may also include individuals who manage the various workflow (e.g., content creation, content personalization) and various other functions of the platform. The personalizing features for the media content or website may be generated with minimal user input. For example, a user (e.g., retailor, merchant, marketing managers, content managers, sales people, recruiters, marketers, etc) may not be required to possess webpage design, machine learning, analytics or content creation expertise in order to generate a desired website or content with the personalization features. The provided systems and methods may beneficially be used by non-expert or to non-technical end users and can be conveniently used for websites, applications or other software.

The personalization platform may provide various front-end features to increase customer engagement and allow for an easy customization of such features. The front-end features created by the personalization platform may provide dynamic content (e.g., variant catalog, images, blogs, text, etc.). The personalization platform may be used to provide various features that are capable of creating dynamic user experience thereby increasing the click through rate, bounce rate and product purchases. For example, the personalization platform may provide features with the ability to add content variants, provide features to automatically render the optimal content for each user as well as the capability to display any web element with dynamic content (e.g., images, blogs, text, etc.).

In some embodiments, the personalization platform may provide features for personalized product recommendations. For instance, features such as product catalog may be personalized per each individual customer there by increasing the conversion rate, revenue, bounce rate and converting existing customers into repeated customers. For example, the personalization platform may provide an intelligent product catalog enrichment feature, a full product catalog ranking feature, individualized product recommendations per user, enabling displaying of any web element with product recommendations and various other features.

The personalization platform may provide dynamic social media content that is relevant to a given user thereby increasing brand loyalty and retention, click through rate, monthly active users and the like. For example, the personalization platform may provide features for integration with social platforms, displaying social content individualized per user, displaying any web element with dynamic social content (e.g., social image catalog).

The personalization platform can provide various other features for personalizing content such as electronic mail (Email). For instance, the personalization platform may provide features allowing for fast and simple connection to Email service provider (ESP) platforms, generating emails/newsletters personalized on a per-user basis, the ability to customize any email template element to be personalized. The personalization platform can generate personalized content and recommendations in an email delivered to the target individual user thereby increasing the monthly active users, and conversion rate. The content and recommendations can be personalized at a per-user level.

The personalization platform may be capable of automating the process of integrating personalizing features to the content and website with improved efficiency and personalization capability. In particular, the personalization platform may provide automation and modular features allowing for creation of the personalization features or AI-enabled products (e.g., product recommendations, catalog recommendations, etc.) and content for personalization (e.g., report, brochures, digital magazines, product guides, sales playbooks, sales proposals, whitepapers, newsletters, company handbooks, annual reports, etc.) with reduced time and improved personalization at granular level. For example, the personalization platform may allow for easy integration, configuration, control and management of personalizing features (e.g., personalized catalog recommendation or product recommendation) by providing analytics features, smart elements (e.g., dynamic HTML elements), advanced ruleset engine, features to understand the personalization rulesets and their impact, features to track and manage the historical change of the smart elements, rulesets and active models, and features for administrative management of the platform.

In some cases, the provided systems may employ artificial intelligence techniques to generate intelligent product catalog enrichment feature, enable full product catalog ranking, predict individualized product recommendations per user, analyze the customer interaction data to extract the intelligence and insight, generate personalized recommendations, or generate content-based recommendations.

Artificial intelligence, including machine learning algorithms, may be used to train a predictive model for predicting a recommendation (e.g., catalog, content, message, user intent, user interest, etc.), extracting the usage analytics, performance analytics, impact analytics as described above, and various other functionalities as described elsewhere herein. A machine learning algorithm may be a neural network, for example. Examples of neural networks that may be used with embodiments herein may include a deep neural network, convolutional neural network (CNN), and recurrent neural network (RNN). In some cases, a machine learning algorithm trained model may be pre-trained and implemented on the provided personalization system, and the pre-trained model may undergo continual re-training that may involve continual tuning of the predictive model or a component of the predictive model (e.g., classifier) to adapt to changes in the implementation environment over time (e.g., changes in the customer/user data, insight and analytics data, model performance, third-party data, etc.).

The term “labeled data” or “labeled dataset,” as used herein, generally refers to a paired dataset used for training a model using supervised learning. The labeled data may be generated by expert or using auto-labeling techniques. Alternatively, methods provided herein may utilize an un-paired training approach allowing a machine learning method to train and apply on existing datasets that may be available with an existing system. In some cases, the training method may include semi-supervised learning or unsupervised learning. For example, the training method may involve pre-training one or more components of the predictive model, an adaptation stage that involves training the predictive model to adapt to a customer to which the pre-trained model is applied, and an optimization stage that involves further continual tuning of the predictive model or a component of the predictive model (e.g., classifier) to adapt to changes in the implementation environment over time (e.g., changes in the target site, model performance, customer-specific data, etc.).

Reference throughout this specification to “some embodiments,” or “an embodiment,” means that a particular feature, structure, or characteristic described in connection with the embodiment is included in at least one embodiment. Thus, the appearances of the phrase “in some embodiment,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” “unit” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In some cases, a component can emulate an electronic component via a virtual machine, e.g., within a cloud computing system.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

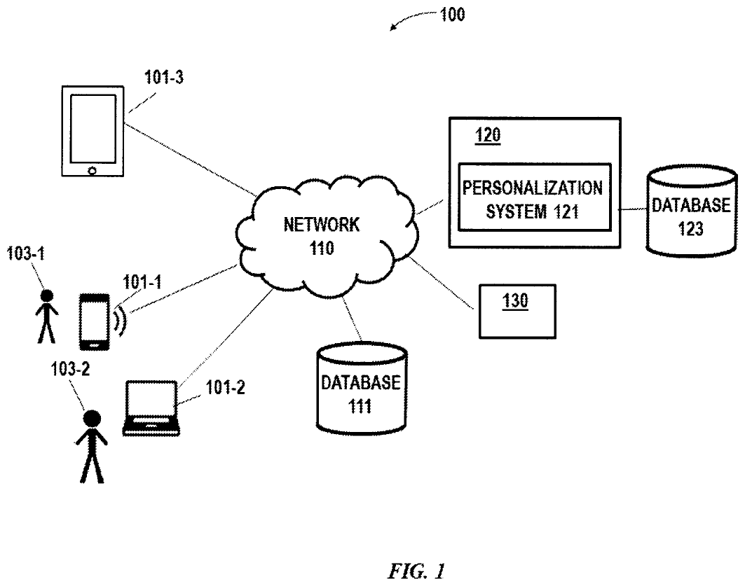

FIG. 1 schematically shows a network or personalization platform 100 in which the method and system for automated personalization can be implemented. A platform 100 may include one or more user devices 101-1, 101-2, 101-3, a server 120, a personalization system 121, one or more third-party systems 130, and a database 111, 123. Each of the components 101-1, 101-2, 101-3, 111, 123, 120, 130 may be operatively connected to one another via a network 110 or any type of communication link that allows transmission of data from one component to another.

The personalization system 121 may be configured to permit users (e.g., merchant, sales manager, content creators, personalizers, analyzers, administers, etc.) to incorporate or integrate personalization features (e.g., smart elements, tracker plugin, etc.) to an existing website, modify and manage smart elements, generate or modify a set of rules associated with a personalization product and manage various aspects of the platform. The personalization system 121 may include a plurality of functional components such as an AI engine, personalization engine, user interface module and the like. Details about the various functional components are described later herein.

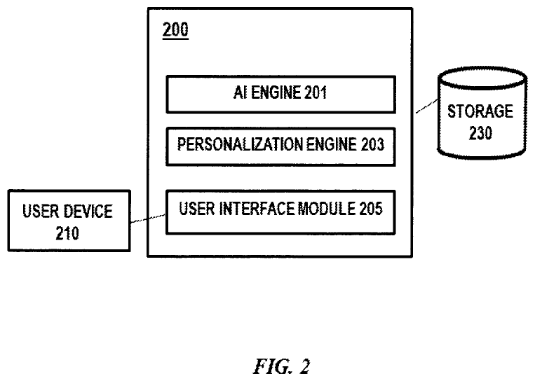

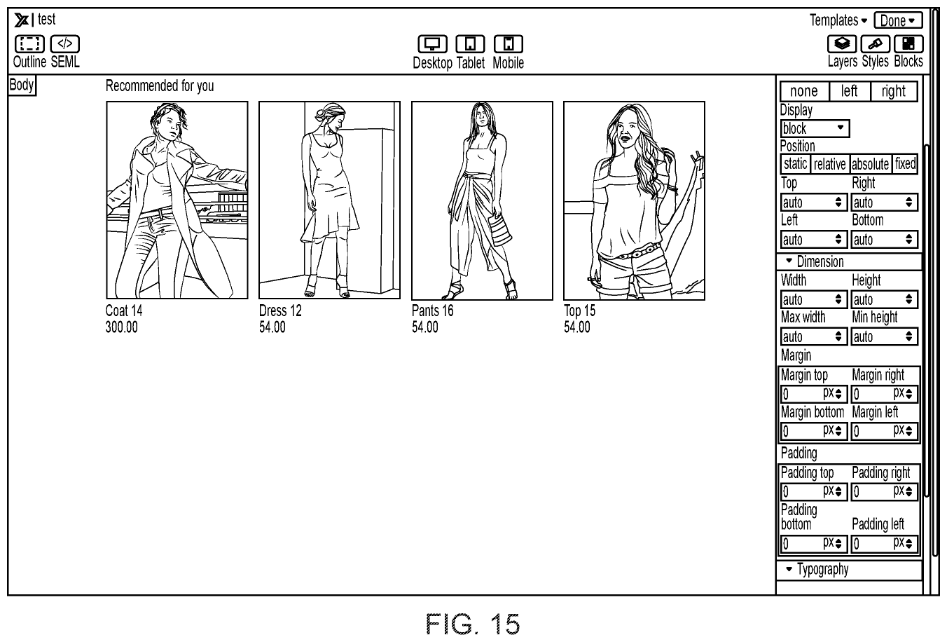

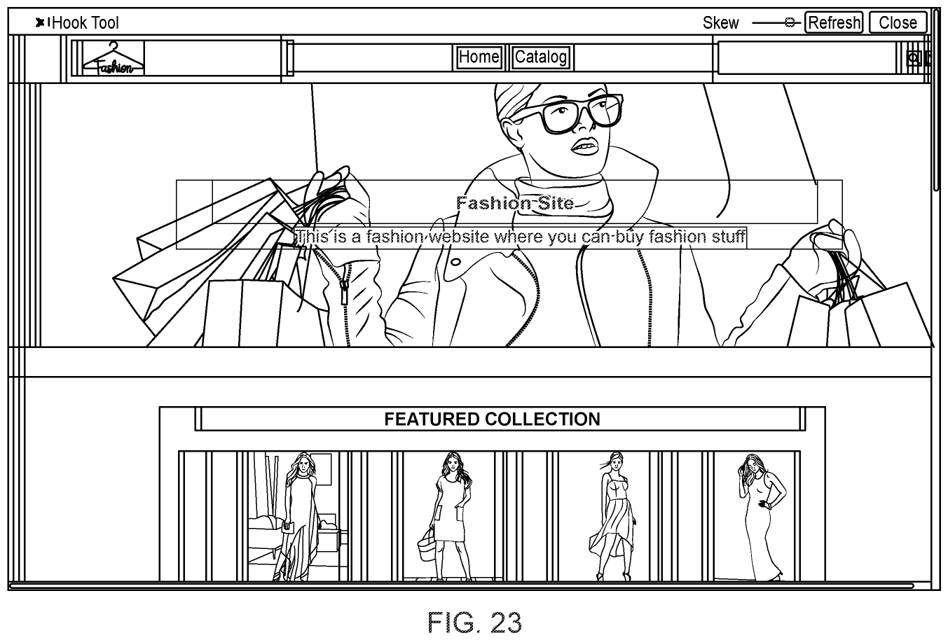

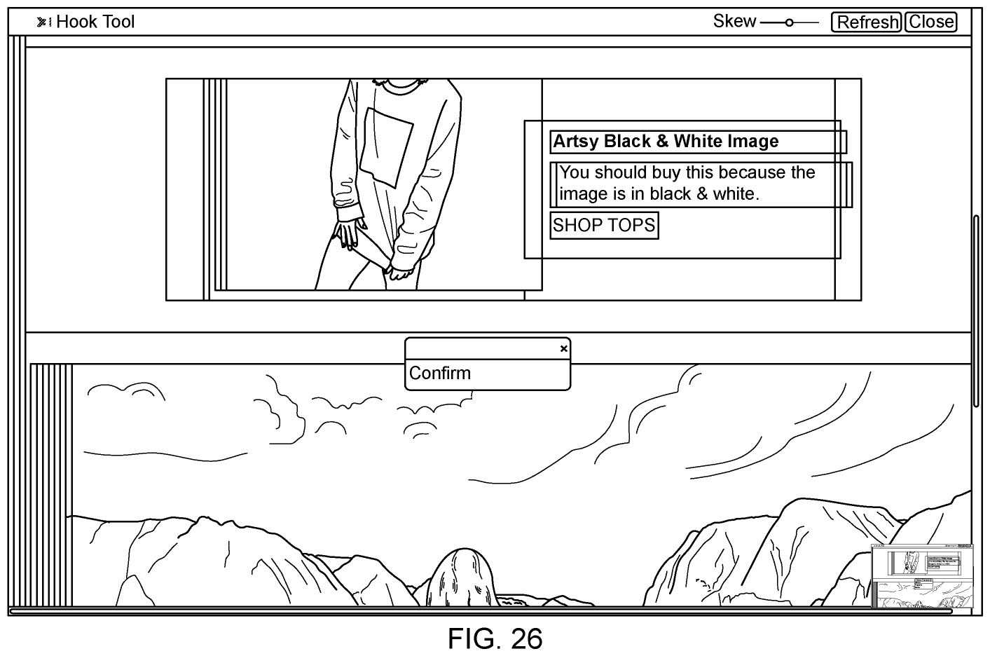

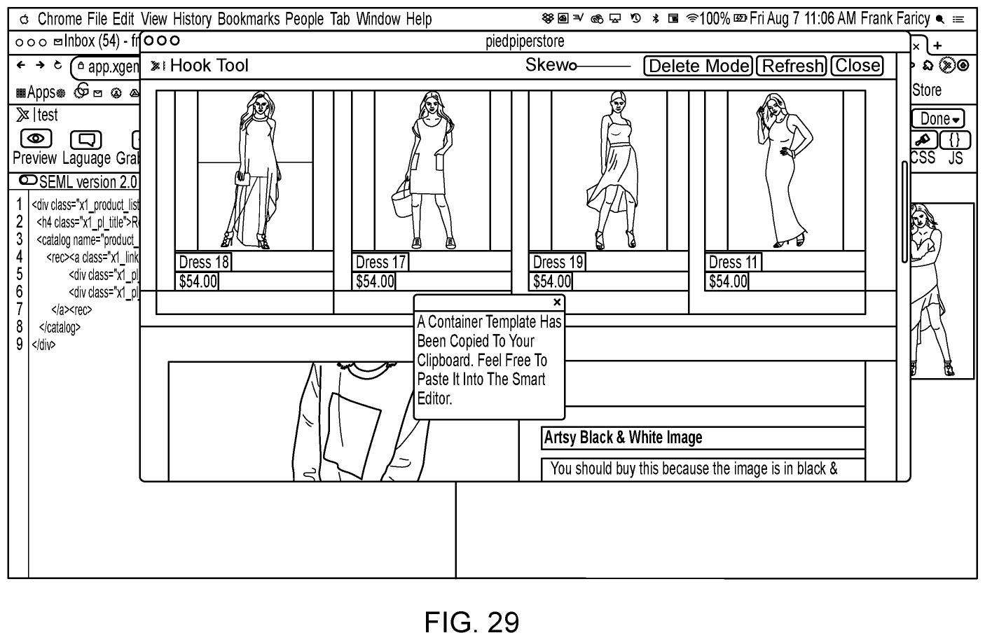

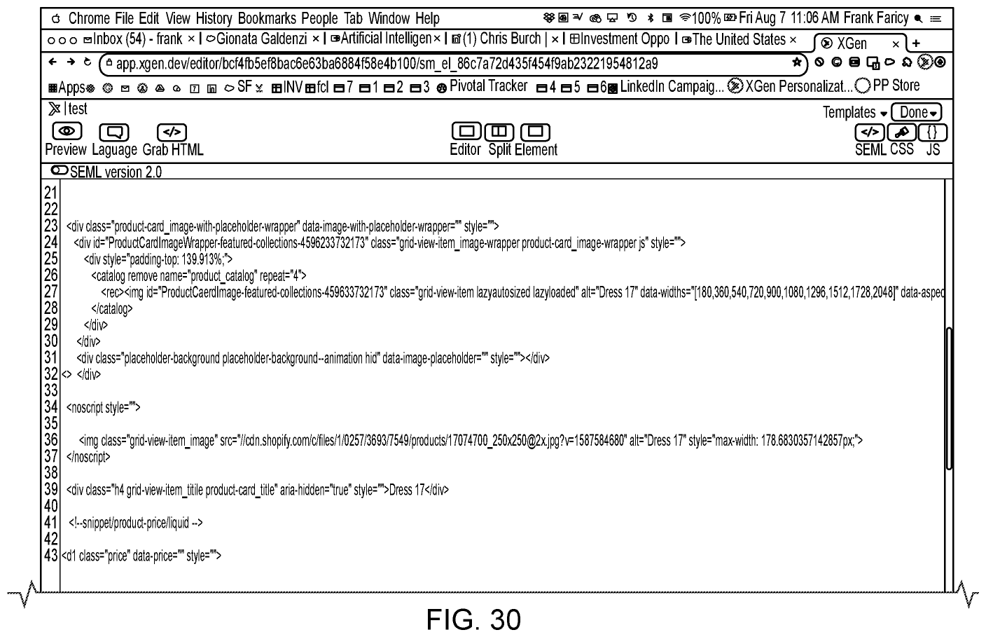

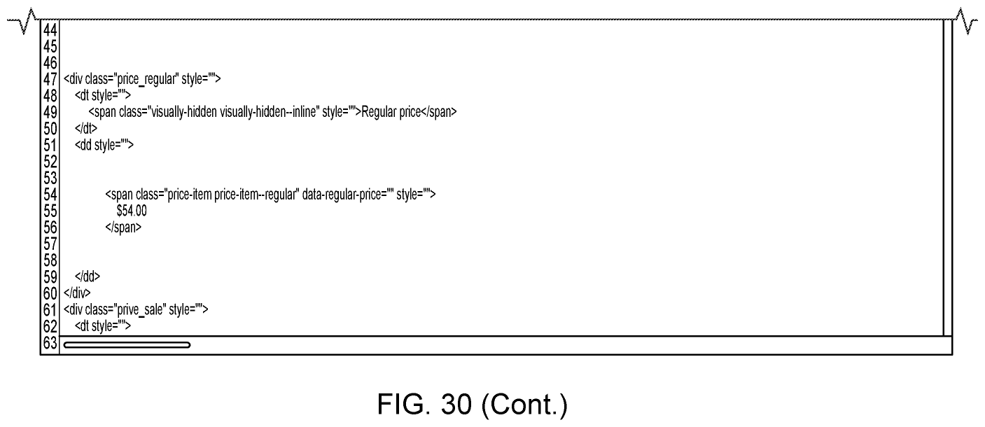

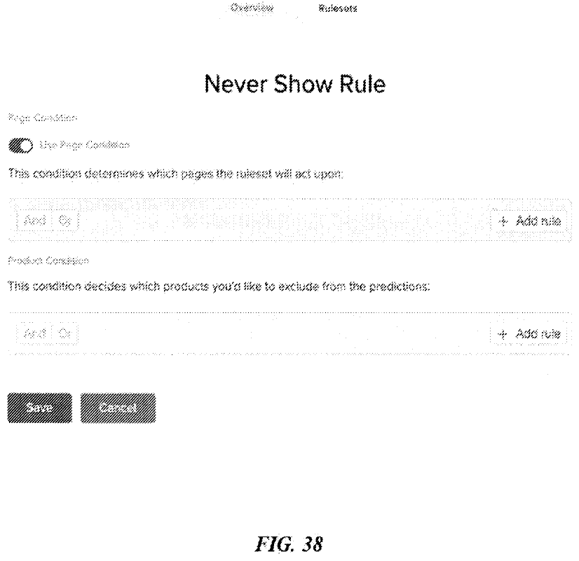

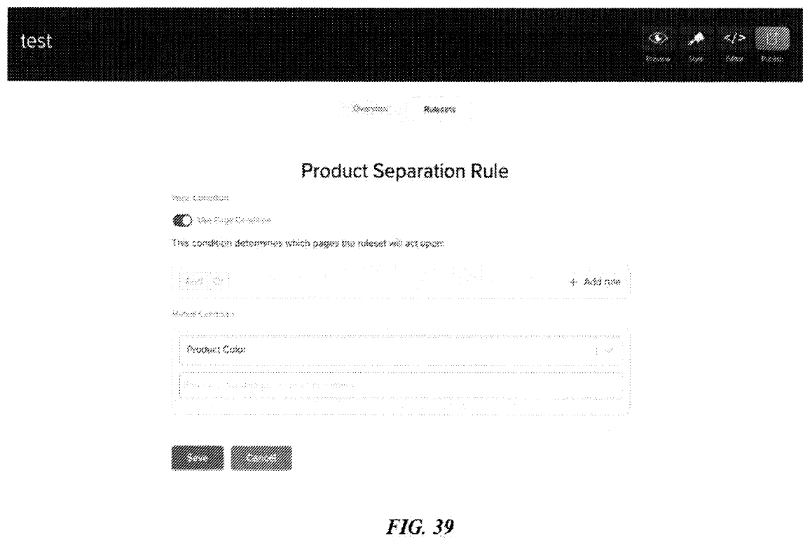

In some cases, the personalization system 121 may be configured to train one or more predictive models (e.g., RNN, CNN) for making predictions on the personalized recommendations, content, services or experiences. The personalization system 121 may be configured to perform one or more operations and provide one or more features consistent with those disclosed with respect to FIGS. 2-42.

In some cases, the personalization system 121 may provide front-end features (e.g., tracker plugin) that are configured to track, analyze and extract insight about how a customer interact with a website and/or personalized content. In some cases, the AI-based recommendations (e.g. product catalog) may be rendered on a target e-commerce site with tracking features (e.g., web analytics tracker), that is capable of extracting intelligence and insight for a variety of applications. For instance, data may be collected indicative of customer interaction with the target site and user behavior. In some cases, the data may be analyzed to extract metrics and usage analytics measuring the degree to which media content were provided or made available to and viewed by customers (e.g., the number of times a content item was pitched to customers), to extract performance metrics measuring the degree to which visitors have engaged with (e.g., clicked, read, edited, shared, saved) the content (e.g., the dwell time on an item, such as the amount of time that the content was displayed in a content viewer (e.g., web browser or other application), to extract impact analytics indicative of the personalized elements' impact on business metrics (e.g., average revenue per pitch of a content item that may be obtained from other systems, such as customer relationship management (CRM) systems, marketing automation systems, etc.), and various other analytics. Such analytics may be used to further retrain, continually train or update a predictive model.

The personalization system 121 may be implemented anywhere within the platform, and/or outside of the platform 100. In some embodiments, the personalization system 121 may be implemented on the server 120. In other embodiments, a portion of the personalization system 121 may be implemented on the user device. Additionally, a portion of the personalization system 121 may be implemented on the third-party system. Alternatively or in addition to, a portion of the personalization system 121 may be implemented in one or more databases 111, 123. The content personalization system 121 may be implemented using software, hardware, or a combination of software and hardware in one or more of the above-mentioned components within the platform. Details about the personalization system 121 are described in FIG. 2.

In some embodiments, a user (e.g., development team, merchant, retailor, etc.) 103-1, 103-2 may be associated with one or more user devices 101-1, 101-2, 101-3. User device 101-1, 101-2, 101-3 may be a computing device configured to perform one or more operations consistent with the disclosed embodiments. Examples of user devices may include, but are not limited to, laptop or notebook computers, desktop computers, mobile devices, smartphones/cellphones, wearable device (e.g., smartwatches), tablets, personal digital assistants (PDAs), media content players, television sets, video gaming station/system, virtual reality systems, augmented reality systems, microphones, or any electronic device capable of analyzing, receiving (e.g., receiving user input in one or more fields for modifying rulesets, creating and editing smart elements, etc.), providing or displaying certain types of data (e.g., rendering of smart elements on a target site, etc.) to a user. The user device may be portable. In some cases, the user device may be located remotely from a human user, and the user can control the user device using wireless and/or wired communications. The user device can be any electronic device with a display.

User device 101-1, 101-2, 101-3 may include one or more processors that are capable of executing non-transitory computer readable media that may provide instructions for one or more operations consistent with the disclosed embodiments. The user device may include one or more memory storage devices comprising non-transitory computer readable media including code, logic, or instructions for performing the one or more operations. The user device may include software applications provided by the personalization system 121 that allow the user device to communicate with and transfer data between server 120, the personalization system 121, and/or database 111.

The user device 101-1, 101-2, 101-3 may include a communication unit, which may permit the communications with one or more other components in the platform 100. In some instances, the communication unit may include a single communication module, or multiple communication modules. In some instances, the user device may be capable of interacting with one or more components in the platform 100 using a single communication link or multiple different types of communication links.

User device 101-1, 101-2, 101-3 may include a display. The display may be a screen. The display may or may not be a touchscreen. The display may be a light-emitting diode (LED) screen, OLED screen, liquid crystal display (LCD) screen, plasma screen, or any other type of screen. The display may be configured to show a user interface (UI) or a graphical user interface (GUI) rendered through an application (e.g., via an application programming interface (API) executed on the user device). The GUI may display, for example, a client portal with various features such as analytics, smart element editors, preview of the smart elements, and the like. The user device may also be configured to display webpages and/or websites on the Internet. One or more of the webpages/websites may be hosted by server 120, the third-party system 130 and/or rendered by the personalization system 121.

In some cases, users may utilize the user devices to interact with the personalization system 121 by way of one or more software applications (i.e., client software) running on and/or accessed by the user devices, wherein the user devices and the personalization system 121 may form a client-server relationship. For example, the user devices may run dedicated mobile applications or software applications for accessing the client portal provided by the personalization system 121. The software applications for managing the platform, creating personalization features, and for rendering and delivering the content may be different applications. Alternatively or additionally, the client application may comprise different modes for a user to modify a smart element, to view analytics associated with a target site, to manage the AI engine, respectively.

In some cases, the client software (i.e., software applications installed on the user devices 101-1, 101-2, 101-3) may be available either as downloadable software or mobile applications for various types of computer devices. Alternatively, the client software can be implemented in a combination of one or more programming languages and markup languages for execution by various web browsers. For example, the client software can be executed in web browsers that support JavaScript and HTML rendering, such as Chrome, Mozilla Firefox, Internet Explorer, Safari, and any other compatible web browsers. The various embodiments of client software applications may be compiled for various devices, across multiple platforms, and may be optimized for their respective native platforms.

In some cases, the provided platform may generate one or more graphical user interfaces (GUIs) for the content personalizer interface. The GUIs may be rendered on a display screen on a user device (e.g., a personalizer's device). A GUI is a type of interface that allows users to interact with electronic devices through graphical icons and visual indicators such as secondary notation, as opposed to text-based interfaces, typed command labels or text navigation. The actions in a GUI are usually performed through direct manipulation of the graphical elements. In addition to computers, GUIs can be found in hand-held devices such as MP3 players, portable media players, gaming devices and smaller household, office and industry equipment. The GUIs may be provided in software, a software application, a mobile application, a web browser, or the like. The GUIs may be displayed on a user device (e.g., desktop computers, laptops or notebook computers, mobile devices, smart phones, personal digital assistants (PDAs), and tablets).

User devices may be associated with one or more users. In some embodiments, a user may be associated with a unique user device. Alternatively, a user may be associated with a plurality of user devices. A user may be registered with the platform. In some cases, for a registered user, user profile data may be stored in a database (e.g., database 123) along with a user ID uniquely associated with the user. The user profile (e.g., personalizer profile) data may include, for example, user names, user ID, identity, business field, contact information, historical data, and various others as described elsewhere herein.

A server 120 may access and execute the personalization system 121 to perform one or more processes consistent with the disclosed embodiments. In certain configurations, the personalization system may be software stored in memory accessible by a server (e.g., in memory local to the server or remote memory accessible over a communication link, such as the network). Thus, in certain aspects, the personalization system(s) may be implemented as one or more computers, as software stored on a memory device accessible by the server, or a combination thereof. In some embodiments, one or more systems or components of the present disclosure are implemented as a containerized application (e.g., application container or service containers). The application container provides tooling for applications and batch processing such as web servers with Python or Ruby, JVMs, or Hadoop or HPC tooling. The various functions performed by the client terminal and/or the personalization system such as creating smart elements, generating ruleset for further modifying AI predictions, training a predictive model, executing a trained model, updating and retraining a model and the like may be implemented in software, hardware, firmware, embedded hardware, standalone hardware, application specific-hardware, or any combination of these. The personalization system, and techniques described herein may be realized in digital electronic circuitry, integrated circuitry, specially designed ASICs (application specific integrated circuits), computer hardware, firmware, software, and/or combinations thereof. These systems, devices, and techniques may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, and/or device (such as magnetic discs, optical disks, memory, or Programmable Logic Devices (PLDs)) used to provide machine instructions and/or data to a programmable processor.

The third-party system 130 can be any entities that provide content, services, e-commerce that is to be personalized via the platform 100. The third-party entity may provide services in a wide range such as online merchant, customer CRM, external content assets (e.g., social media, online resource), public or private resources and various others. In some cases, the third-party system 130 may be in communication with the personalization system via APIs such that the third-party content library, service information, inventory, product catalog, brand style availability information and the like can be communicated.

In some cases, the server 120 may also be configured to store, search, retrieve, and/or analyze data and information stored in one or more of the databases. The data and information may include tracked customer interaction data collected by the tracker plugin as well as predicted data, personalized content, user data, ruleset associated with a personalization products, data about a predictive model (e.g., parameters, model architecture, training dataset, performance metrics, threshold, etc.), data generated by a predictive model such as personalization options or extracted insight, recommendations, and the like. While FIG. 1 illustrates the server as a single server, in some embodiments, multiple devices may implement the functionality associated with a server.

A server may include a web server, an enterprise server, or any other type of computer server, and can be computer programmed to accept requests (e.g., HTTP, or other protocols that can initiate data transmission) from a computing device (e.g., user device) and to serve the computing device with requested data. In addition, a server can be a broadcasting facility, such as free-to-air, cable, satellite, and other broadcasting facility, for distributing data. A server may also be a server in a data network (e.g., a cloud computing network).

A server may include known computing components, such as one or more processors, one or more memory devices storing software instructions executed by the processor(s), and data. A server can have one or more processors and at least one memory for storing program instructions. The processor(s) can be a single or multiple microprocessors, field programmable gate arrays (FPGAs), or digital signal processors (DSPs) capable of executing particular sets of instructions. Computer-readable instructions can be stored on a tangible non-transitory computer-readable medium, such as a hard disk, a CD-ROM (compact disk-read only memory), and MO (magneto-optical), a DVD-ROM (digital versatile disk-read only memory), a DVD RAM (digital versatile disk-random access memory), or a semiconductor memory. Alternatively, the methods can be implemented in hardware components or combinations of hardware and software such as, for example, ASICs, special purpose computers, or general purpose computers.

Network 110 may be a network that is configured to provide communication between the various components illustrated in FIG. 1. The network may be implemented, in some embodiments, as one or more networks that connect devices and/or components in the network layout for allowing communication between them. For example, user device 101-1, 101-2, 101-3 third-party system 130, server 120, personalization system 121, and database 111, 123 may be in operable communication with one another over network 110. Direct communications may be provided between two or more of the above components. The direct communications may occur without requiring any intermediary device or network. Indirect communications may be provided between two or more of the above components. The indirect communications may occur with aid of one or more intermediary device or network. For instance, indirect communications may utilize a telecommunications network. Indirect communications may be performed with aid of one or more router, communication tower, satellite, or any other intermediary device or network. Examples of types of communications may include, but are not limited to: communications via the Internet, Local Area Networks (LANs), Wide Area Networks (WANs), Bluetooth, Near Field Communication (NFC) technologies, networks based on mobile data protocols such as General Packet Radio Services (GPRS), GSM, Enhanced Data GSM Environment (EDGE), 3G, 4G, 5G or Long Term Evolution (LTE) protocols, Infra-Red (IR) communication technologies, and/or Wi-Fi, and may be wireless, wired, or a combination thereof. In some embodiments, the network may be implemented using cell and/or pager networks, satellite, licensed radio, or a combination of licensed and unlicensed radio. The network may be wireless, wired, or a combination thereof.

User device 101-1, 101-2, 101-3, third-party system 130, server 120, or personalization system 121, may be connected or interconnected to one or more database 111, 123. The databases may be one or more memory devices configured to store data. Additionally, the databases may also, in some embodiments, be implemented as a computer system with a storage device. In one aspect, the databases may be used by components of the network layout to perform one or more operations consistent with the disclosed embodiments. One or more local databases, and cloud databases of the platform may utilize any suitable database techniques. For instance, structured query language (SQL) or “NoSQL” database may be utilized for storing the content or personalized data, ruleset data, customer/visitor analytics data, historical data, predictive model, training datasets, or algorithms. Some of the databases may be implemented using various standard data-structures, such as an array, hash, (linked) list, struct, structured text file (e.g., XML), table, JavaScript Object Notation (JSON), NOSQL and/or the like. Such data-structures may be stored in memory and/or in (structured) files. In another alternative, an object-oriented database may be used. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. In some embodiments, the database may include a graph database that uses graph structures for semantic queries with nodes, edges and properties to represent and store data. If the database of the present invention is implemented as a data-structure, the use of the database of the present invention may be integrated into another component such as the component of the present invention. Also, the database may be implemented as a mix of data structures, objects, and relational structures. Databases may be consolidated and/or distributed in variations through standard data processing techniques. Portions of databases, e.g., tables, may be exported and/or imported and thus decentralized and/or integrated.

In some embodiments, the platform 100 may construct the database for fast and efficient data retrieval, query and delivery. For example, the personalization system 121 may provide customized algorithms to extract, transform, and load (ETL) the data. In some embodiments, the personalization system 121 may construct the databases using proprietary database architecture or data structures to provide an efficient database model that is adapted to large scale databases, is easily scalable, is efficient in query and data retrieval, or has reduced memory requirements in comparison to using other data structures. The document or content items may be stored in a pre-defined structured data format that are described later herein.

In some embodiments, the one or more database systems 123, 111, which may be configured for storing or retrieving relevant data. Relevant data may comprise tracked customer interaction data collected by the tracker plugin, personalized content, user data, ruleset associated with a personalization products, data about a predictive model (e.g., parameters, model architecture, training dataset, performance metrics, threshold, etc.), data generated by a predictive model such as personalization options or extracted insight, recommendations, and various other data as described elsewhere herein. In some cases, the personalization system 121 may source data or otherwise communicate (e.g., via the one or more networks 110) with one or more external systems or data sources 111, such as one or more product catalogs, media sources, analytics services, customer management services or databases. In some instances, the personalization system 121 may retrieve data from the database systems 111, 123 which are in communication with the one or more external systems (e.g., external media assets, etc.) or third-party systems 130 (e.g., third-party business entities, enterprise management software, customer management platforms, etc.).

In some cases, the database may store data related to machine learnmg-based models. For example, the database may store data about a trained personalized predictive model (e.g., parameters, hyper-parameters, model architecture, performance metrics, threshold, rules, etc.), data generated by a personalized predictive model (e.g., intermediary results, output of a model, latent features, input and output of a component of the model system, etc.), training datasets (e.g., labeled data, insight provided by expert, etc.), predictive models, algorithms, and the like. The database can store algorithms or ruleset utilized by one or more methods disclosed herein. For instance, user-defined ruleset to be used in combination with machine learning trained models for customizing a model prediction or AI-based product may be stored in the database. In certain embodiments, one or more of the databases may be co-located with the server, may be co-located with one another on the network, or may be located separately from other devices. One of ordinary skill will recognize that the disclosed embodiments are not limited to the configuration and/or arrangement of the database(s).

In some cases, data stored in the databases or external databases can be utilized or accessed by a variety of applications through application programming interfaces (APIs). Access to the database may be authorized at per API level, per data level (e.g., type of data), per application level or according to other authorization policies.

Although particular computing devices are illustrated and networks described, it is to be appreciated and understood that other computing devices and networks can be utilized without departing from the spirit and scope of the embodiments described herein. In addition, one or more components of the network layout may be interconnected in a variety of ways, and may in some embodiments be directly connected to, co-located with, or remote from one another, as one of ordinary skill will appreciate.

Various aspects of the present disclosure may be applied to any of the particular applications set forth below or for any other types of applications or systems. Systems or methods of the present disclosure may be employed in a standalone manner, or as part of a package.

FIG. 2 schematically shows a diagram of a personalization system 200, in accordance with various embodiment of the present disclosure. In some cases, the personalization system 200 may provide advanced and dynamic personalization to websites (e.g., e-commerce sites) that may increase user engagement and conversion rate. In some embodiments, the system 200 may comprise an AI engine 201, a personalization engine 203, and a user interface module 205. The system may optionally comprise a user interface 210 for creating, modifying, managing and deploying various features provided by the system. Alternatively, the user interface may be a separate component that is operably coupled to the system 200. The personalization system 200 may be the same as the personalization system as described in FIG. 1.

In some embodiments, the AI engine 201 may be configured to train, develop, manage a set of models for providing the personalization features (e.g., personalized recommendation). The AI engine may generate a plurality of AI-based outputs/products such as product recommendations, dynamic content, dynamic social content and various other personalizing features as described elsewhere herein.

In some cases, one or more machine learning-based models may be trained and developed to generate individualized product recommendations for each user. The product recommendation may include, for example, full product catalog ranking feature that takes the site's entire product catalog into account on each recommendation. The predicted results may not be limited to analyzing bestsellers or specific groups of products. As an example, each recommendation may be a full product catalog ranked from first to last of how likely a given user is to engage with the product.

In some cases, one or more machine learning-based models may be developed to generate personalized content (e.g., hero images, blog carousels, category images, etc.) that is dynamically displayed with specific content variants for each individual customer. In some cases, one or more machine learning based models may be trained to generate predicted image recommendations directly from the social media platforms connected to the site thereby increasing brand loyalty and retention.

In some cases, the AI engine may comprise a model management system for model creation and model management. The model management system may include a model monitor system that monitors data drift or performance of a model in different phases (e.g., development, deployment, prediction, validation, etc.). The model monitor system may also perform data integrity checks for models that have been deployed in a development, test, or production environment. The model monitor system may be configured to perform data/model integrity checks and detect data drift and accuracy degradation. The process may begin with detecting data drift in training data and prediction data. During training and prediction or detection, the model monitor system may monitor difference in distributions of training data, test, validation and prediction or detection data, change in distributions of training data, test, validation and prediction or detection data over time, covariates that are causing changes in the prediction output, and various others.

In some cases, the model monitor system may perform one or more integrity tests on a model and the results may be displayed on a model management console. For example, the integrity test result may show the number of failed predictions, percentage of row entries failed the test, execution time of the test, and details of each entry. Such results can be displayed to users (e.g., developers, manager, etc.) of the platform via the model management console.

Data monitored by the model monitor system may include data involved in model training and during production. The data at model training may comprise, for example, training, test and validation data, predictions, detections, or statistics that characterize the above datasets (e.g., mean, variance and higher order moments of the data sets). Data involved in production time may comprise time, input data, predictions made, and confidence bounds of predictions made. In some embodiments, the ground truth data may also be monitored. The ground truth data may be monitored to evaluate the accuracy of a model and/or trigger retraining of the model. The model monitor system may monitor changes in data such as changes in ground truth data, or when new training data or prediction data becomes available.

The one or more trained predictive or detective models may be individually monitored or retrained if model performance is below a threshold or when new data are available (e.g., data captured by the Tracker plugin). During prediction time, predictions may be associated with the model in order to track data drift or to incorporate feedback from new ground truth data.

One or more of the AI-based recommendations and predictions are delivered through the smart elements. A smart element is a user interface element that displays the predictions. The smart element can be crated, managed, and published by a user via the client portal as described later herein.

The personalization engine 203 may be configured to allow users to create and edit various AI-based products or features and integrate such features to a target website (e.g., third-party e-commerce site). The personalization engine may include a family of plugins, extensions, modules and scripts that facilitate development and integration of AI-based products and services into third-party or customers' platforms.

In some embodiments, the personalization engine 203 may comprise a personalization preview extension allowing users to preview predictions during model training and development phase as well as in the deployment phase. The personalization review extension provides the ability to enable a client to select an individual customer or select groups of customers by filtering specific site behavior and preview what products will be recommended to them. This beneficially allows users to preview the effect/results of AI products/services on-the-fly. Examples of the preview feature are described later herein.

The personalization engine 203 may comprise a product listing page module that creates dynamic product listing pages with search and filtering options that generates ranked product recommendations depending on the search and filtering. The personalization engine 203 may comprise a search module configured to provide ranked product or content recommendations based off of search input from the user. The personalization engine 203 may comprise a popup module configured to provide ranked products or content recommendations through dynamic popups that can be configured to be delivered based on various triggers, timing, exit intent or other triggering events.

The personalization engine 203 may also allow for an easy and flexible integration of the various personalization features into any existing third-party website or platforms. The personalization engine 203 may provide a plurality of options such as raw application programming interface (API), Plugins, Google Tag Manager and the like for integrating the AI-based products to a third-party platform.

In some cases, the API plugin may create various API endpoints for extracting information (e.g., Product Catalogue), smart element rendering and code injection, and module remote configuration. As an example, the API endpoint address url may be https://shopift.xgen.dev. Calling the API may require a specific header to authorize the call. An example of the header values is listed below:

```
X-API-KEY: the api key
X-API-SECRET: the api secret
This key-pair is defined as part of the license_key.
The API returns the results encrypted and compressed.
{
  “key”: “RSA_encoded_ecryption_key”,
  “payload”: “<base_64_encoded_encrypted_compressed_results>”
}
```

A private key may be required to decrypt the message.

The personalization engine may provide plug-and-play integration options through plugins for various platforms such as Shopify, Commerce Cloud, Magento, WooCommerce and various other third-party platforms. In some cases, the plugin may be provided by injecting code into a third-party website. For example, a Tracker plugin may be provided which can inject Tracker code into the customer's website to generate user events and send them to the platform backend. Such events tracked by the Tracker plugin may be used for personalization such as training models, making predictions, and the like. The SmartElement plugin may inject Smart Elements which are created in the client portal into the customer's website. For example, the smart element may be displayed by calling client portal API endpoint.

Tools such as Google Tag Manager may be provided for simple and rapid integration to website that are built on custom platform or websites with further customization requirement. For instance, a Google Tag Manager configuration file may be provided that can be simply uploaded to the third-party platform Google Tag Manager account for integration. Such tools may be used to manage and deploy tags (snippets of code or tracking pixels) on the target website (or mobile app) without having to modify the code.

In some cases, the personalization engine may provide features for setting up integrating configuration for the smart elements to update product catalog from the link to static files (e.g., csv). For example, the personalization engine may include a field mapping plugin that uses a mapping definition to transform the incoming file to an internal product catalog. Each mapping may contain at least two fields: “prod_code” and “prod_name.”

The user interface module 205 may provide a client portal or user portal allowing users to develop, edit, create, manage the personalization features various aspects of the system. The client portal may allow users of the platform to control AI predictions, create and publish smart elements and view the results in real-time.

The client portal may comprise analytics features that allow users to view granular results of the predictions and recommendations within a third-party website. The analytics feature displays key statistics of the third-party website and the relationship to the active personalization on the website. This beneficially allows users to preview the impact or results of the AI-enabled products with real-time feedback.

The client portal may comprise editor features that allow users to create, edit, and manage smart elements (e.g., user interface elements) that display predictions and recommendations on the third-party website. For instance, the smart elements can be created by simply choosing from a number of templates or by using a drag & drop builder that requires no coding. The client portal may also comprise a full HTML, CSS, and JavaScript editor allowing users to create the smart elements at a code level. For instance, the full HTML, CSS, and JavaScript editor may provide a Smart Element Markup Language (SEML) which has been specifically designed to be able to code elements for personalization and rapidly integrate the AI-based products through intuitive tags and selectable variables.

The client portal may further comprise an advanced ruleset engine for configuring or modifying a trained model/AI-based product based on specific use cases or handcrafted rules. The one or more rulesets may be specified/defined to further customize an AI-based product (e.g., personalized catalog recommendation) or limit the predictions based on the rules. For example, users may be permitted to set up rules to display a list of products that all match a specific category or attribute, ensure that multiple brands do not display together on the same page, or (for A/B testing) restrict certain user groups from receiving recommendations and various other user-defined rules.

In some embodiments, the client portal may comprise a personalization potential feature allowing users to preview the impact of the user-specified rules. In some cases, a Personalization Potential score may be generated providing visibility into any AI-based product or model modifications so that the effectiveness of those modifications can be pre-viewed.

The client portal may also comprise a change log feature allowing users to track and view log history of changes in the new elements published, modifications, active models and other components/features of the system.

The client portal may further provide management features allowing users (e.g., administers, clients) to set up roles and permissions to the team members who are working on the same or across projects.

The user interface module 205 may allow users to interact with the AI engine, personalization features, and various other components of the system as described above. The user interface (UI) module may provide a graphical user interface (GUI) that can be integrated into other applications (e.g., client application). For example, user may preview the predictions, edit, save, create smart elements, rulesets, access permissions via the GUI. In some cases, the user interface module may comprise proper extensions (e.g., Chrome Extension) for users to preview smart elements directly on the e-Commerce site as well as tools to help place the smart elements in specific site locations.

In some embodiments, the GUIs may be rendered on a display screen on a user device 210. The user interfaces and functionality described herein may be provided by software executing on the user's computing device, by the personalization system located remotely that is in communication with the computing device via one or more networks, and/or some combination of software executing on the computing device and the agent responder system. The user interfaces may be provided by a cloud computing system.

The database 230 may store the relevant data as described above. In some cases, the database may store personalized recommendations or content. The content may be stored as structured data such as JavaScript object notation (JSON) data. In some embodiments, the smart element may be stored in a pre-defined document schema that contains the data and metadata needed to render each element. The element or content may be created and stored in the database that may be implemented using various standard data-structures, such as an array, hash, (linked) list, struct, structured text file (e.g., XML), table, JSON, NOSQL and/or the like. In some cases, the content item, element or web element, such as a video, an image, a chart, a text file of a document may be stored with one or more different representations (e.g., mobile rendering, desktop rendering, rendering in a browser, rendering in a desktop application, etc.).

### Examples of Automating Personalization

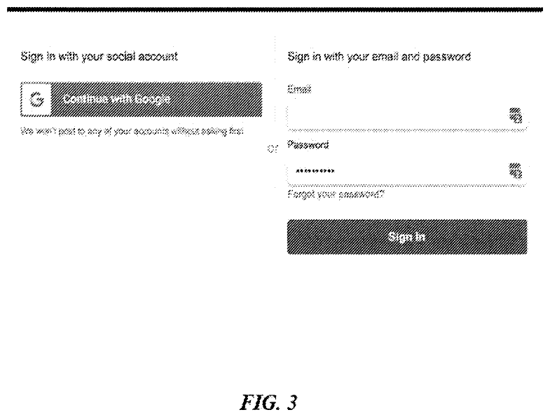

A user (e.g., sales person, website designer, merchant, etc.) may login to a client portal to personalize the target website/contents. FIG. 3 shows an example of signing in or logging into a client portal. For example, a user may be required to provide credentials (e.g., authentication credential) to login a pre-registered account. Once logged in, the client portal may provide various user interfaces that may permit the user to add or edit the personalizing features such as smart elements (e.g., product recommendation), edit a set of rules, test the personalizing features and the like.

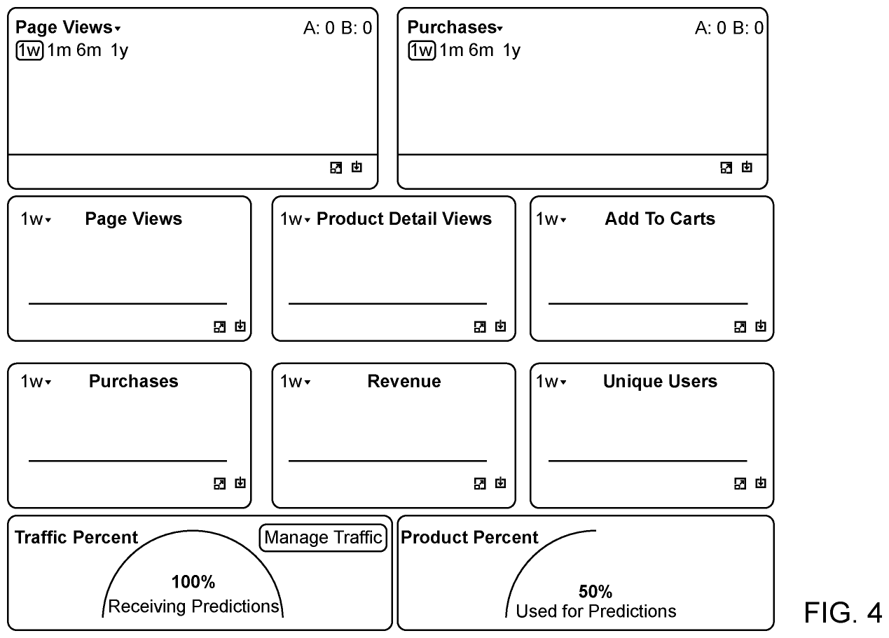

FIG. 4 shows an example of an analytics user interface. As shown in the example, the analytics user interface may provide A/B testing showing two or more variants of a page that is displayed to users at random, and statistical analysis is used to determine which variation performs better for a given conversion goal.

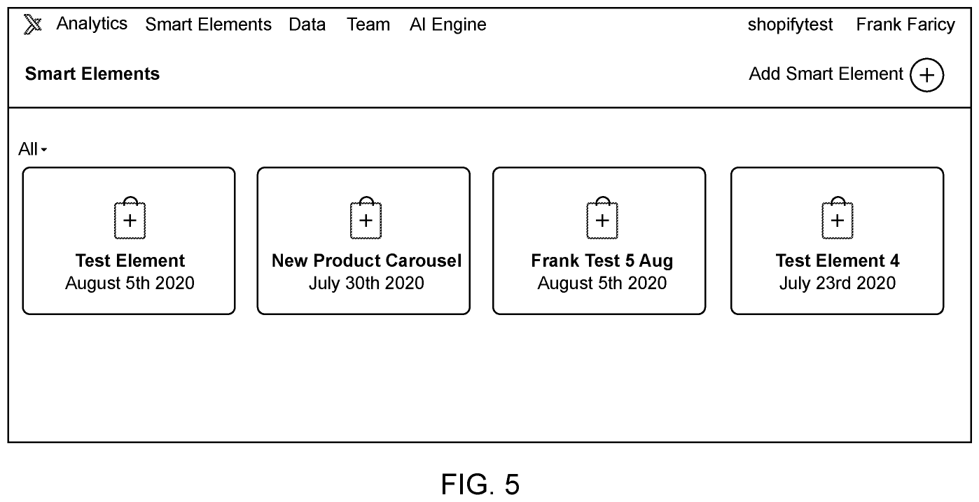

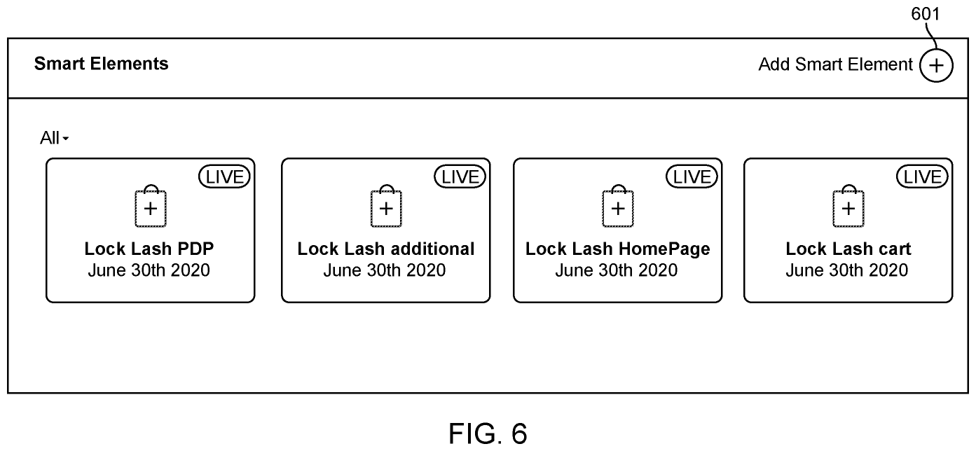

FIG. 5 and FIG. 6 show examples of various smart elements that can be integrated into a third-party platform or target website (e.g., e-commerce website). The user interfaces permit users to create and publish the Smart Element to the target site. For example, user may go to the Smart Elements section and click the “Add Smart Element” plus button 601 to create a new smart element. Details about editing and managing the smart elements are described later herein.

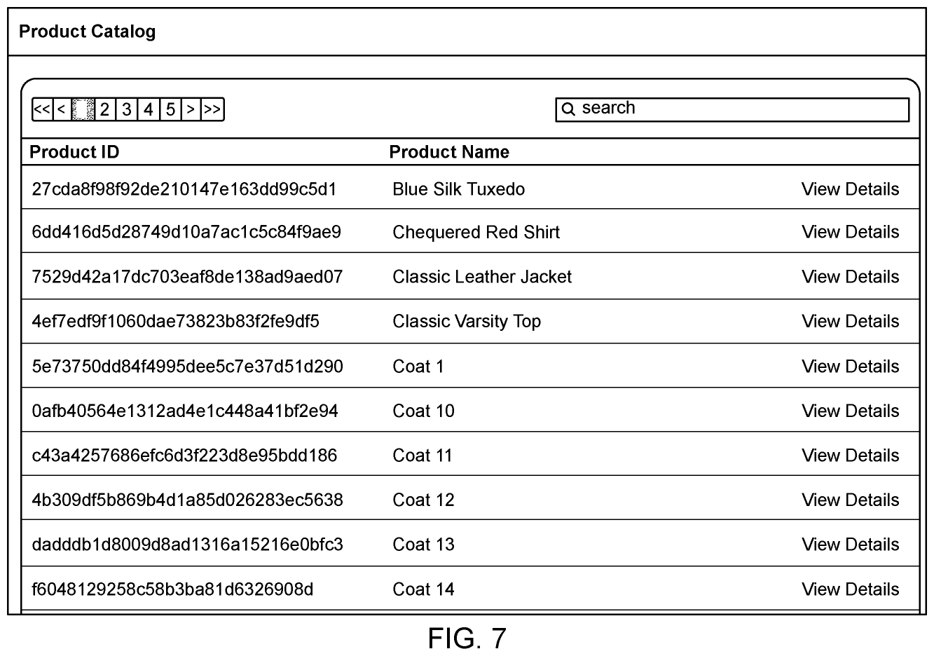

FIG. 7 shows an example of a smart element (e.g., product catalog). In the illustrated example, the prediction result generated by a trained model may be a product catalog personalized for an individual. As described above, the prediction may not be limited to only analyzing bestsellers or specific groups of products. A recommendation may be a full product catalog ranked from first to last of how likely the user is to engage with that product.

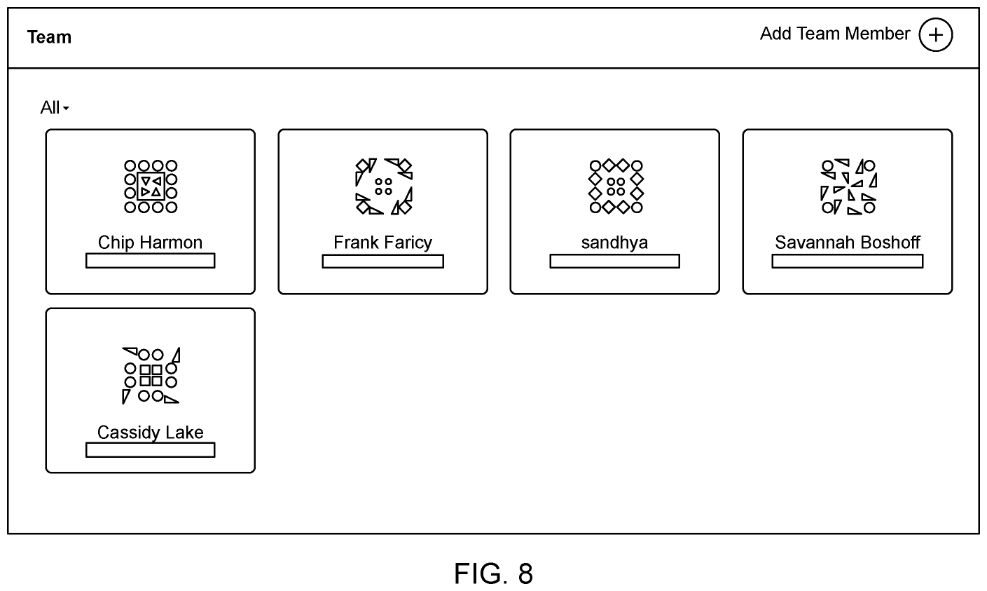

FIG. 8 shows an example of a team section of the user portal. The team section interface may permit users to configure and manage other team members' access to use the personalization system. Different roles may be assigned to different users that give different levels of permissions to the platform.

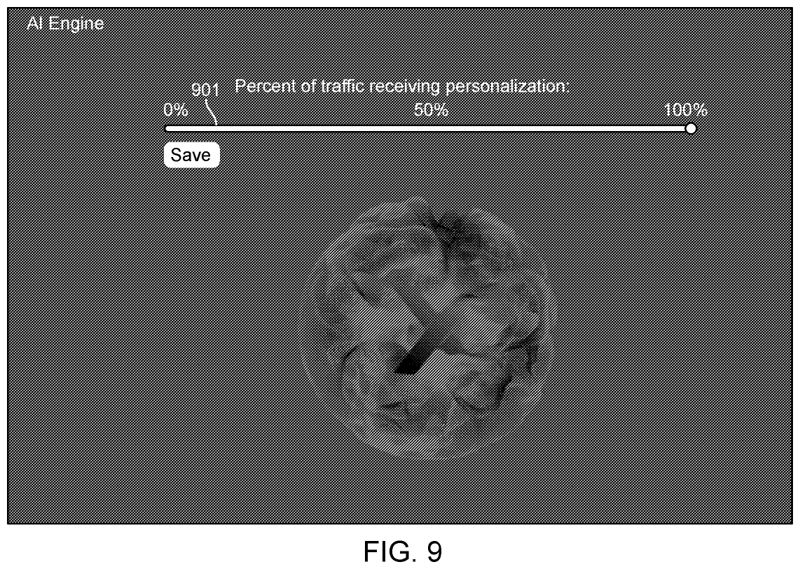

FIG. 9 shows an example of a graphical user interface (GUI) for controlling one or more parameters of an AI engine. As shown in the example, a user may configure the AI engine to provide smart elements to a selected percent of web traffic (e.g., 0%, 50%, or 100% of the site traffic) associated with a target website via the GUI. Web traffic is the amount of data sent and received by visitors to a website. In the example, a sliding bar 901 may be provided such that by sliding from 0% to 100% a user may adjust the percent of traffic for personalization in an intuitive manner.

### Smart Elements GUI

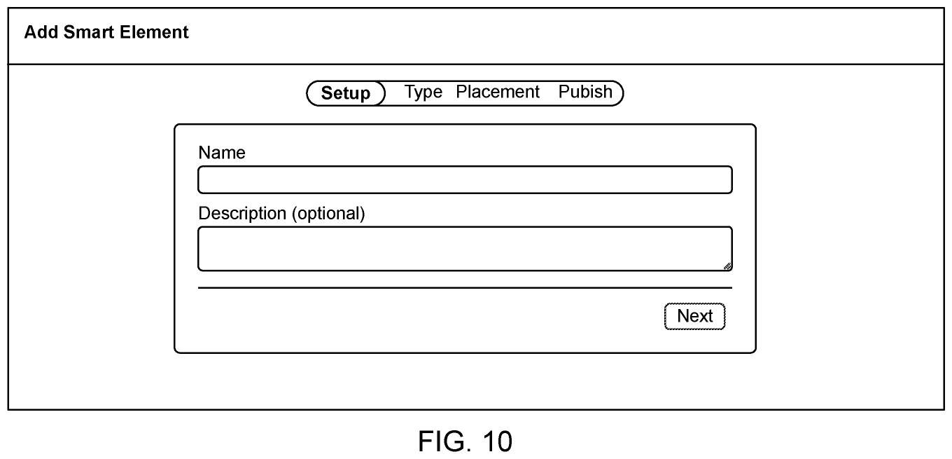

FIGS. 10-13 show various examples of creating, editing and managing smart elements via the GUIs. As shown in FIG. 10, a user may create a new smart element via the GUI. A user may, for example, set up a new smart element by providing a name for the smart element and provide optional description for additional information about the smart element (e.g., intended user and location).

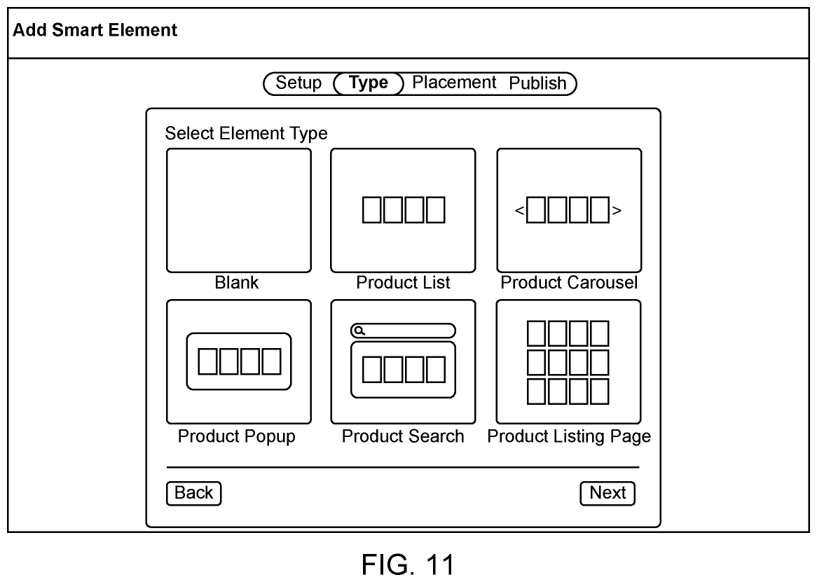

FIG. 11 shows an example of a GUI allowing users to select a type for the smart element. Templates of different types (e.g., blank, product list, product carousel, product popup, product search, product listing page, etc.) may be provided. The type templates can be further customized. The GUI may permit users to build a smart element using smart editor and/or web builder which can be initiated by clicking on the “blank” type.

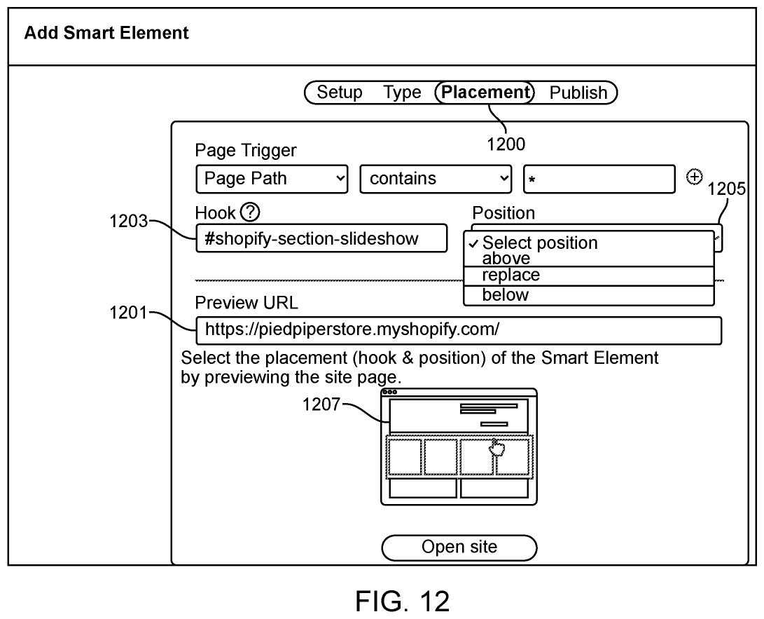

FIG. 12 shows an example of GUI allowing users to select a placement 1200 for the smart element. Within the GUI, a user may specify the location on the target site where the smart element to appear. A user may specify the URL (uniform resource locator) 1201 of the page of the target site. A user may set an identifier (e.g., webhook, HTML ID, class, etc.) for an existing element on the site. The smart element can be specified to be placed with respect to the existing element (e.g., appear above, below, or replace the existing element). For example, a drop-down menu 1205 may provide various position selections placing the smart element with respect to the existing element. The Placement feature 1200 is provided to make it easy to set the hook 1203 and position for the smart element. For example, after setting the Page URL, the target webpage 1207 as located by the URL may automatically popup allowing the user to select from an existing element from the webpage (e.g., hover over existing elements) that is to be placed with the smart element. This beneficially allows for integrating the smart element to any web element with improved flexibility and convenience.

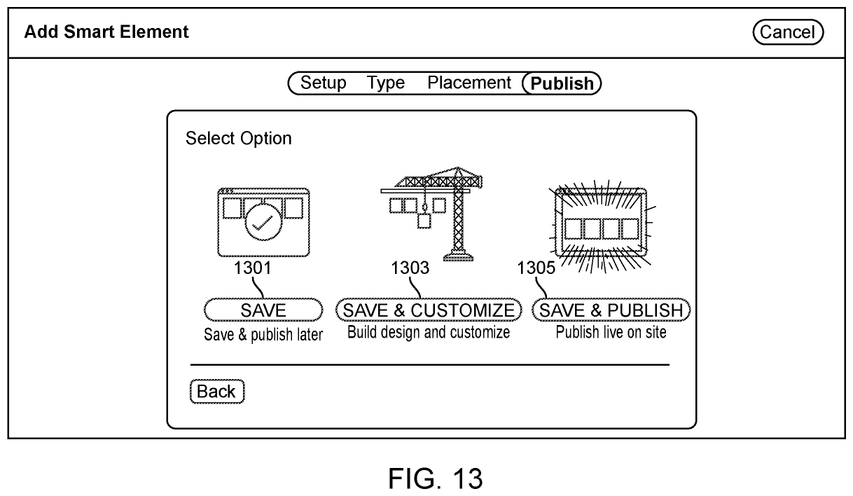

FIG. 13 shows an example of a GUI for publishing a smart element. The smart element can be saved and be made ready for use via the GUI. For example, the save option 1301 may save the smart element without publishing the smart element live on the site. The save & customize option 1303 may save the smart element and redirect the user to the web builder to further customize the smart element. The save & publish option 1305 saves the smart element and publishes it live on the target site. It should be noted that in addition to publishing a smart element via the GUI, a user may publish the smart element by calling a backend API directly.

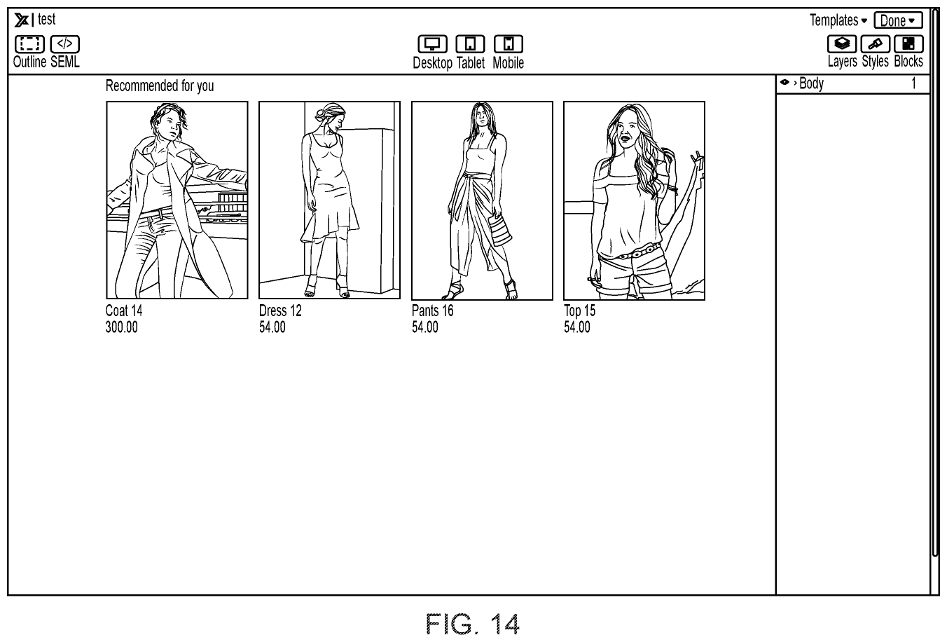

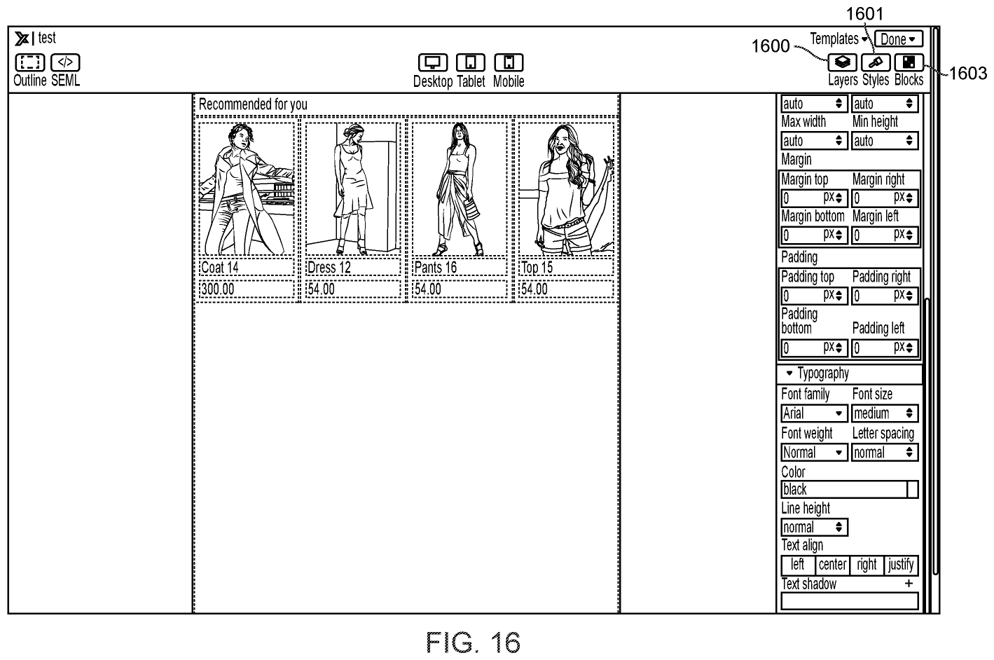

FIGS. 14-27 show various examples of editing, and managing the smart elements by directly interacting with a target site. FIGS. 14-17 show examples of editing smart elements using a drag and drop builder. As shown in the examples, the drag and drop builder allows users to edit or create smart elements without coding. For example, as shown in FIG. 16, the drag and drop builder may provide a Layers function 1600 that opens a list of the elements as layers. Elements can be placed to desired positions by dragging the elements or dragging a layer that represents the element. Various aspects of the elements (e.g., dimension, position, display, padding, typography, font, etc.) can be edited. For example, the elements can be made visible or hidden by clicking on the eye icon in the corresponding layer. The styles function 1601 may open a style editor for a selected element for users to edit or add styles simply by adjusting the settings fields.

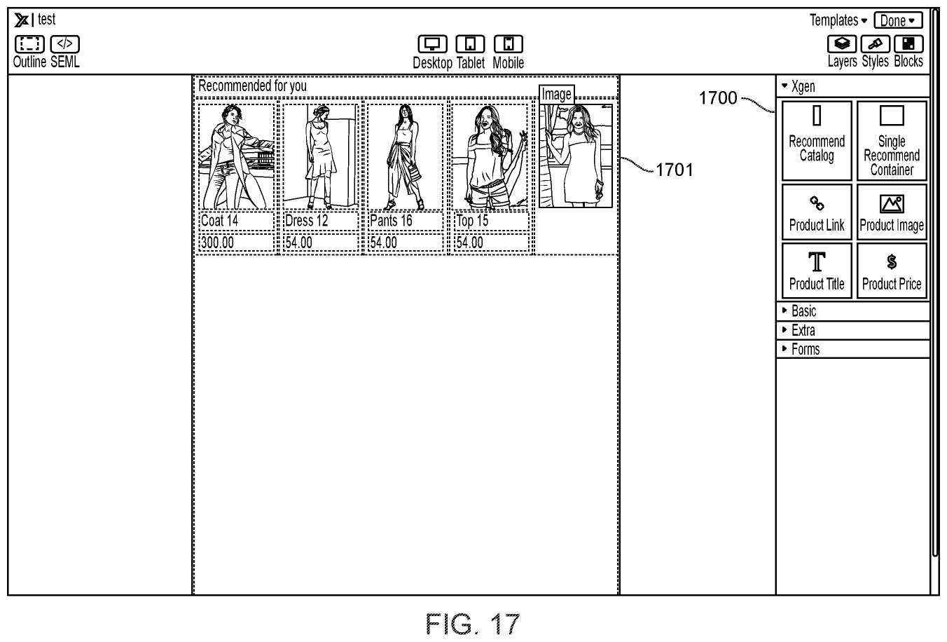

The blocks function 1603 may open a list of website elements blocks that can be dragged into the preview to build the smart element. Any suitable website elements can be represented by the bocks such as images or text. As shown in FIG. 17, the personalization system may provide a unique blocks section 1700 that represents the data provided by the AI engine. For example, dragging a Product Image block 1701 into the element may automatically connect the element to the AI engine and retrieve the product image of the recommendations coming from the AI prediction. This allows for creation of a smart, AI-enabled element with minimal user input.

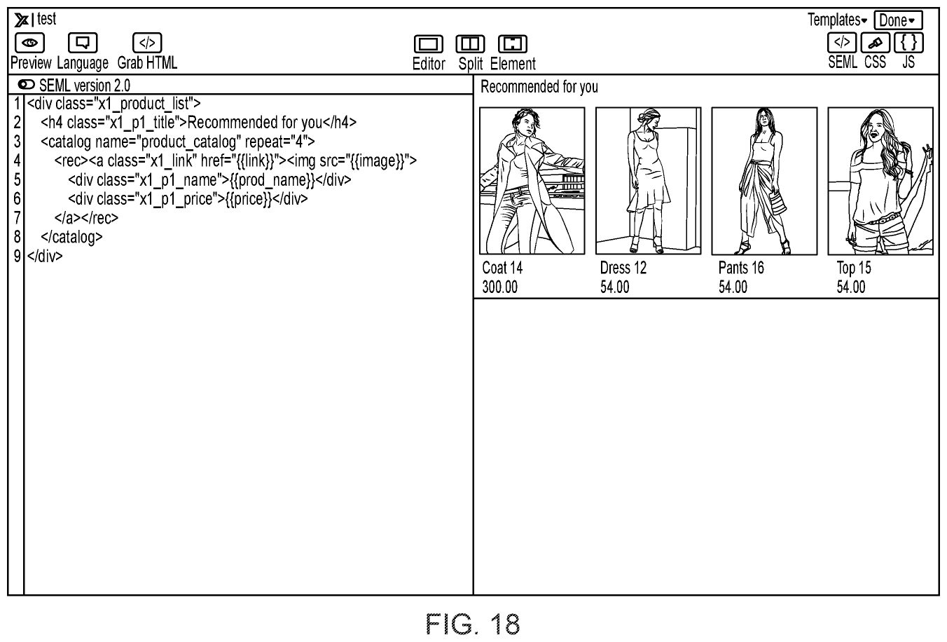

FIGS. 18-21 show examples of editing smart elements using a smart editor. The smart editor allows users to customize the smart elements at the code level. For example, full HTML, CSS, and JavaScript can be written to produce any type of smart element to deliver dynamic product recommendations. The smart editor may include a plurality of features that automate the creation of various frontend UI features and automate the connection between the frontend and the recommendations/predictions generated by the AI engine. Such features may be enabled by the Smart Element Markup Language (SEML) markup language which is specifically designed for creating site personalization.

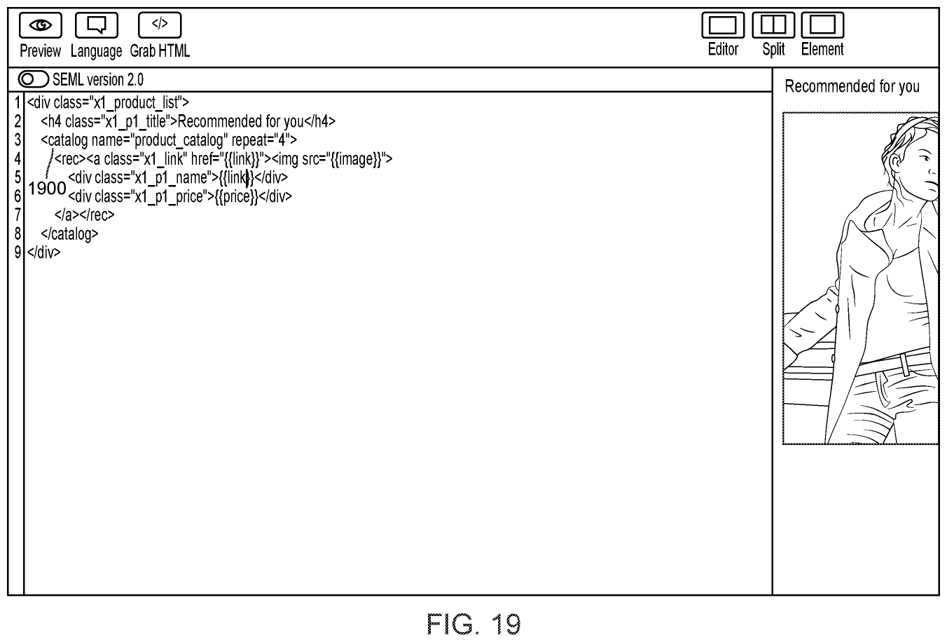

In some cases, to make the building of UI elements for the target site and personalization, SEML provides unique tags that automate UI designs. For example, as shown in FIG. 19, the <catalog/> tag 1900 creates a product list. Its direct child is the <rec/> tag which is used to define the individual product listings. The catalog tag has two attributes:

name: the name of the specific product catalog that recommendations should be pulled from.

repeat: the number of recommendations that should be in the product list. The repeat attribute allows the tag <rec/> only needs to be defined once.

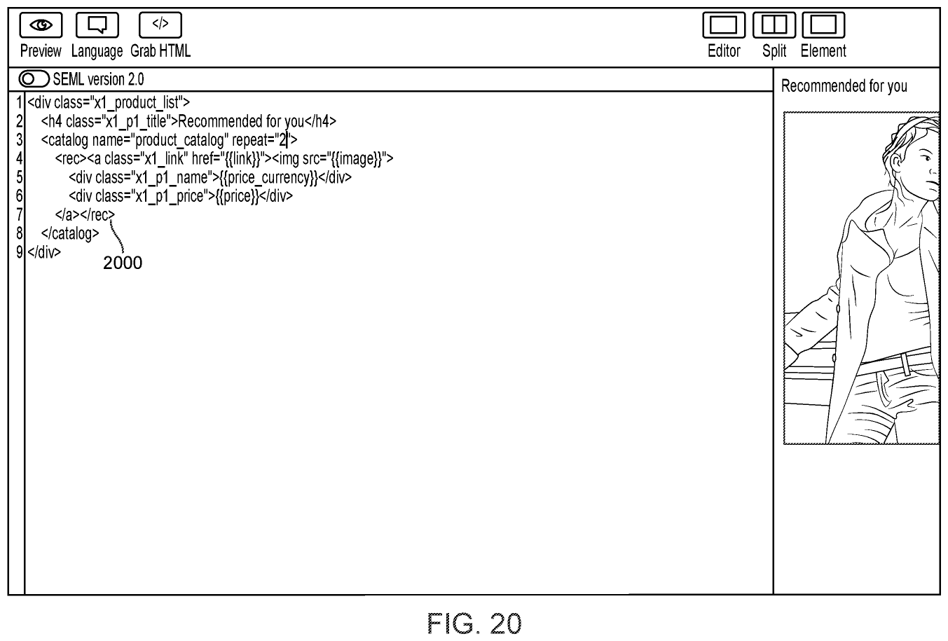

In another example, the <rec/> tag is used to define an individual recommendation. It serves as a wrapper for any markup used to define the context of a product recommendation. As illustrated in FIG. 20, any markup inside a <rec/> tag 2000 may be repeated as the standard markup for the product listings of the corresponding smart element.

The SEML may have the ability to automatically connect/link the API response from the AI Engine directly to the element. This may be performed through the use of a template placeholder. For example, the <rec/> tag may trigger the following:

1. Type “{{}}” and inside that “{{}}” press CONTROL+SPACE on the keyboard.

2. This will create a dropdown of items that can be selected to go into that place such as image or price.

3. The smart editor will automatically populate that part of the recommendation with the designated item such as populating the element with the product image or product price of that recommendation.

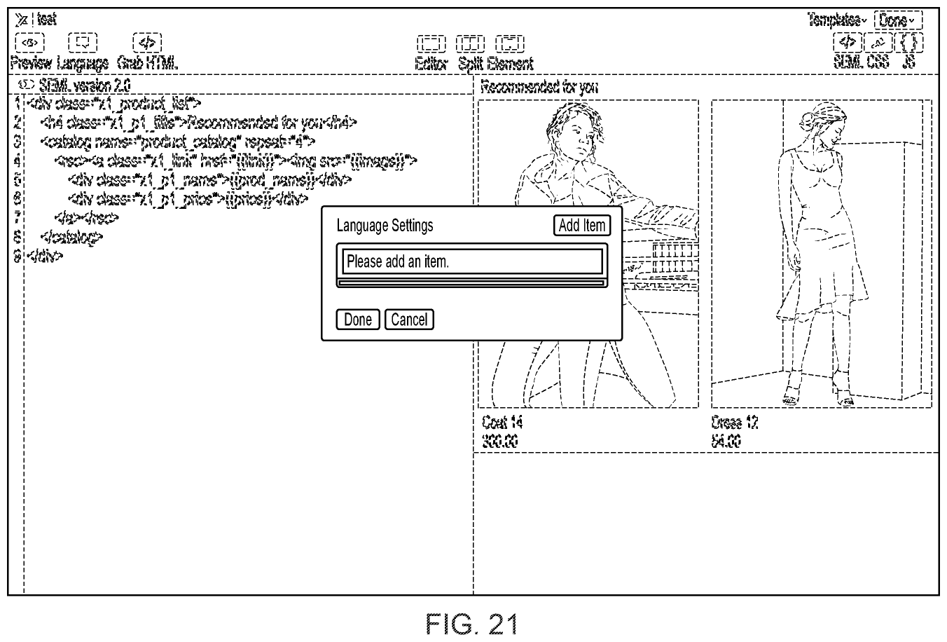

The SEML may enable language settings as shown in FIG. 21. For static text (e.g., text that is not from an API response) such as a product carousel title, the SEML provides a language setting option to translate the text based on the localization of the third-party platform.

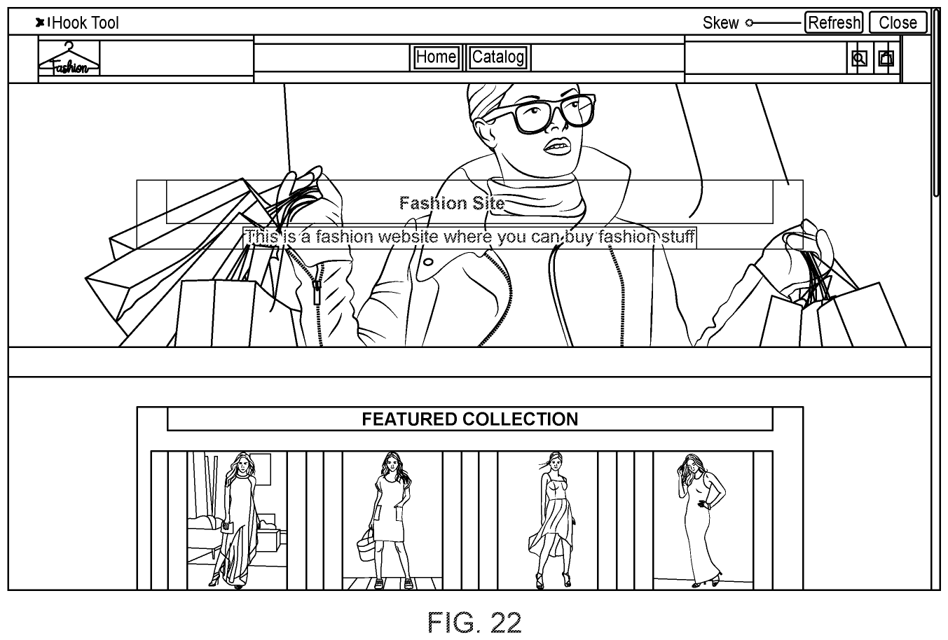

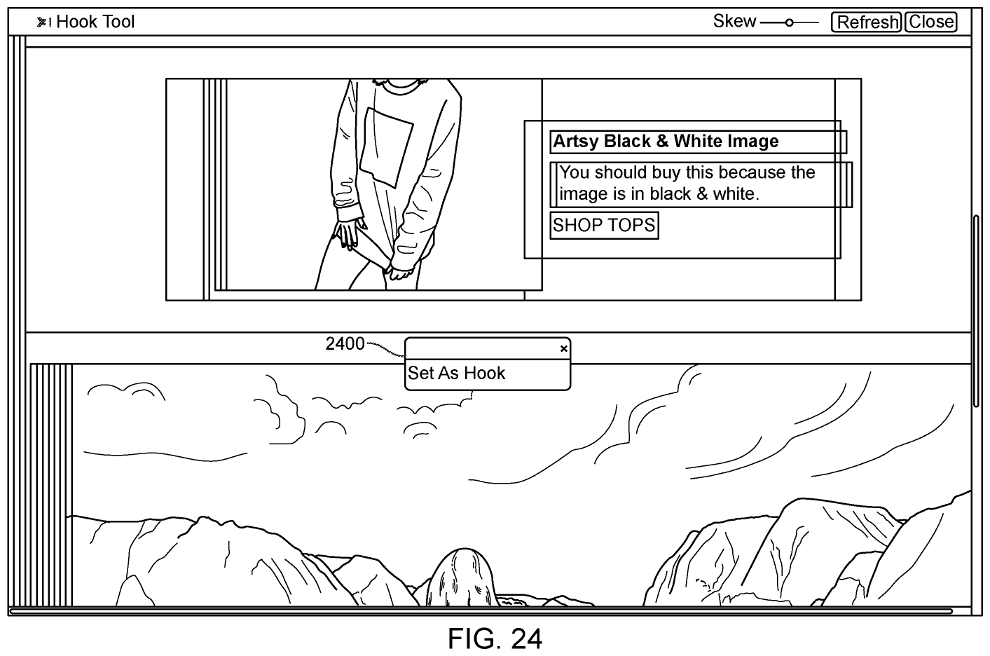

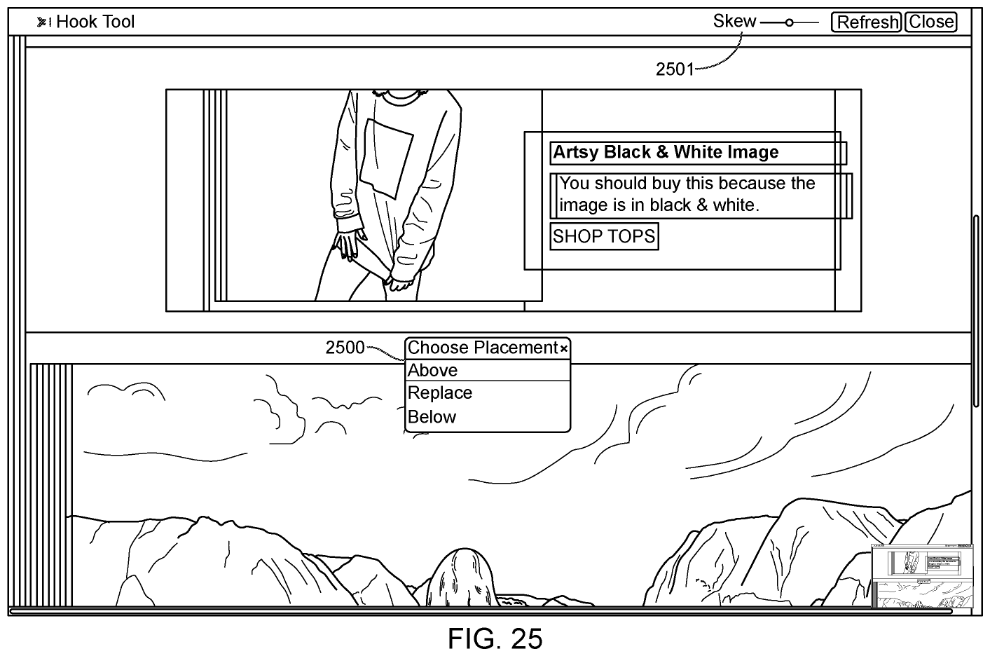

FIGS. 22-26 show examples of a placement tool of the user portal. The placement tool is provided to make it easy to set the hook and position for the smart element by visually specifying multiple fields (e.g., Hook, Position) directly on the site. As descried above, a hook field is an identifier for an existing element on the site. The smart element can be placed with respect to the existing element. For instance, the position field specifies that a smart element can be placed above, below, to the left/right, or replace the “hook” element. As an example, after setting the Page URL, the webpage may popup allowing the user to select from an existing element (e.g., hover over existing elements) that is to be placed with the smart element. As shown in the examples of FIGS. 22-26, the selected site element may be outlined to be easily distinguished from other elements by hovering over the element. Clicking on an element may open a context menu where the hook and position can be set. FIG. 24 shows an example of clicking on an existing element to bring up a window 2400 for setting up hook. As shown in FIG. 25 a context menu 2500 may be displayed allowing a user to choose a placement of the hook with respect to the selected element (e.g., above, replace, below, etc.). This beneficially allows for integrating the smart element to any web element with improved flexibility and convenience. The placement tool may also include a skew slider 2501 for moving any overlapping elements on the site to the right and make it easier to select specific elements as a hook.

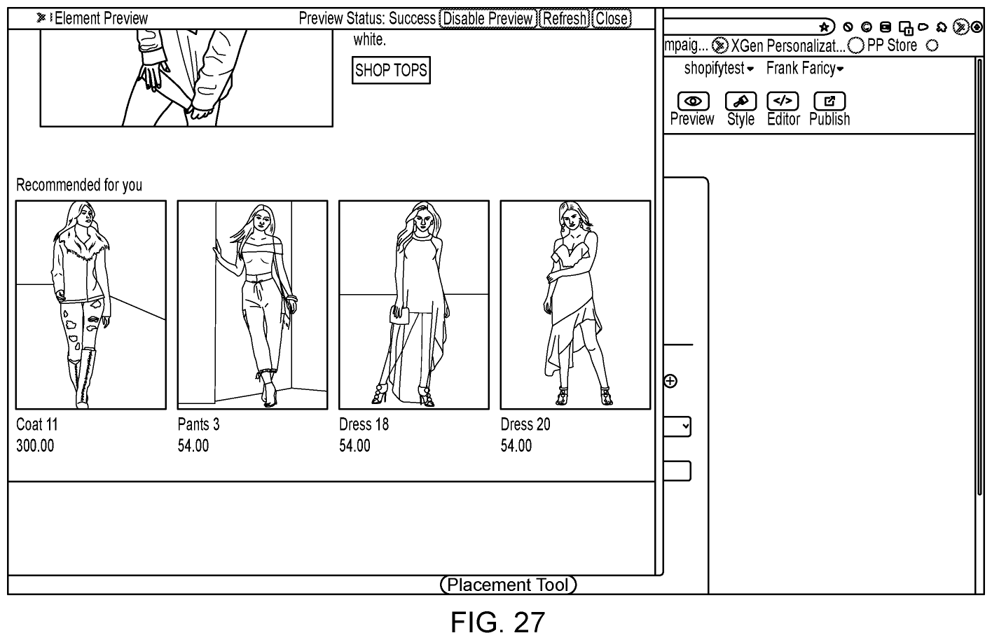

FIG. 27 shows an example of previewing the smart elements. The preview feature may permit users to preview the smart elements prior to be published to the target site and after published to the site. For example, users may click on the preview button to open the target site and render the element on the target site. The webpage may be loaded (to a memory accessible by the) to render the element in the user portal window for preview without publishing the element.

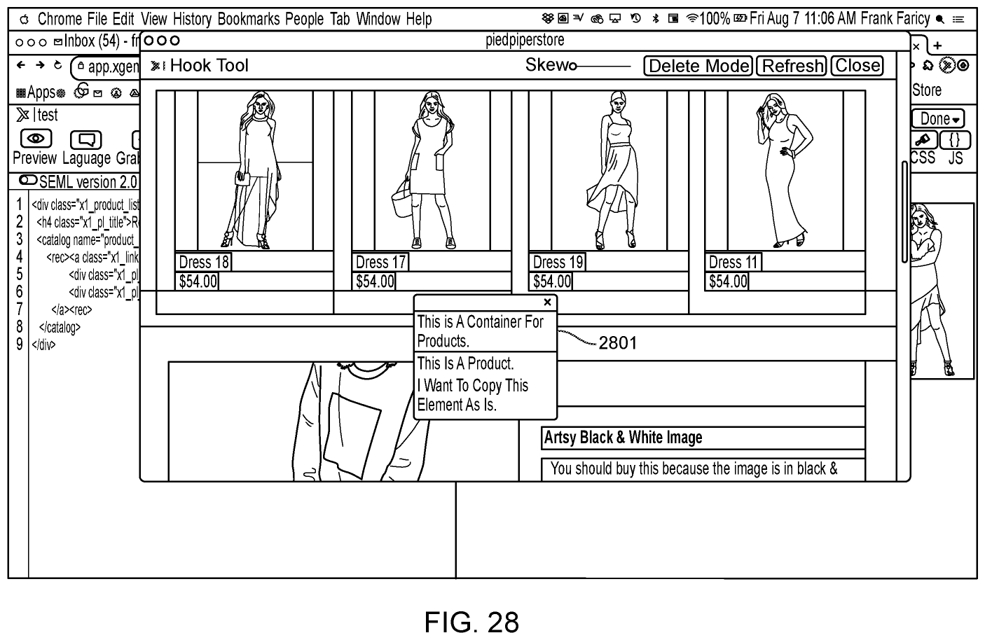

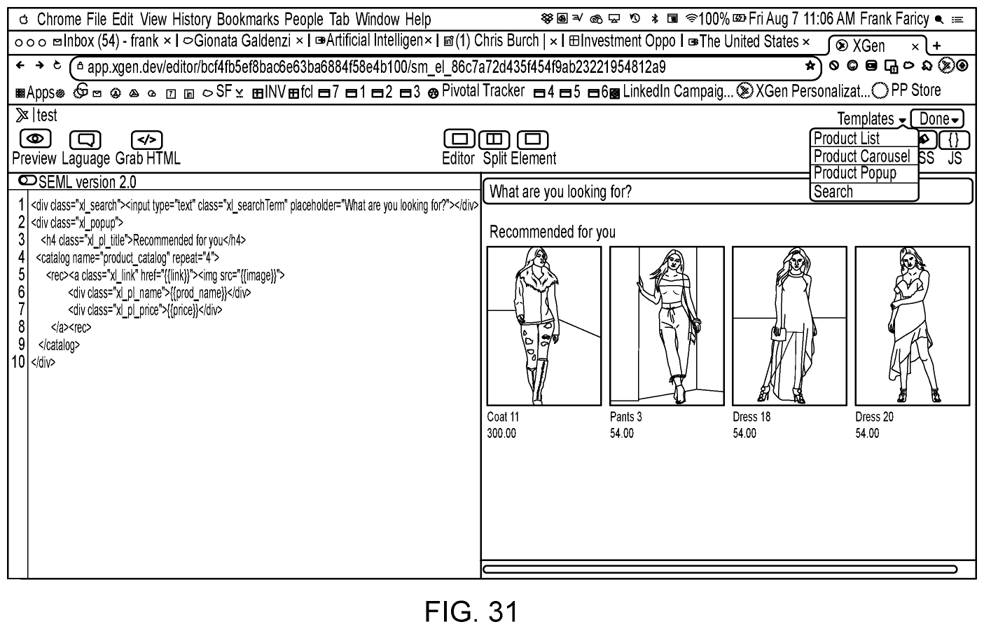

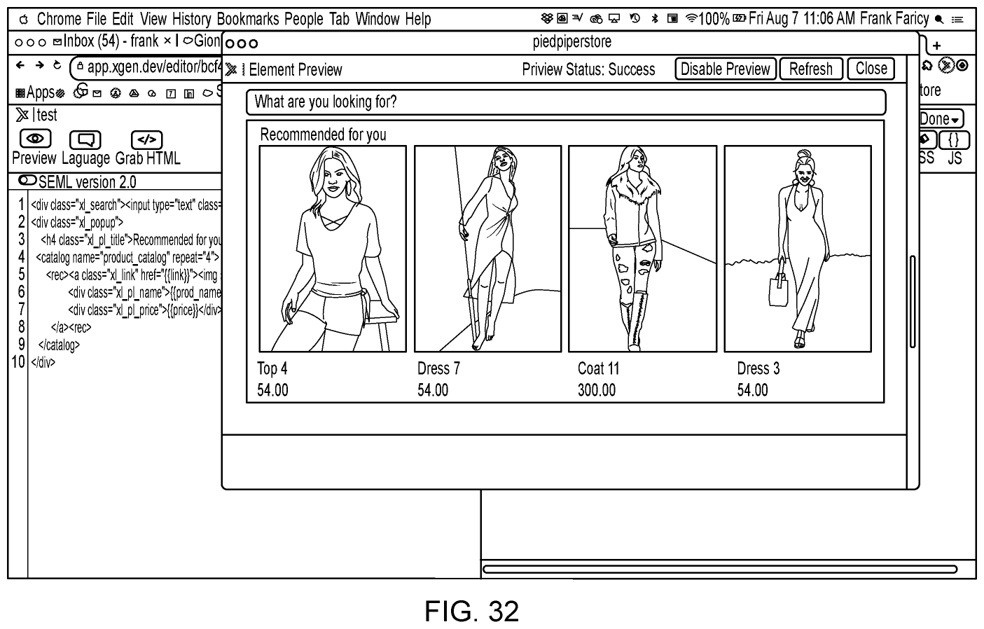

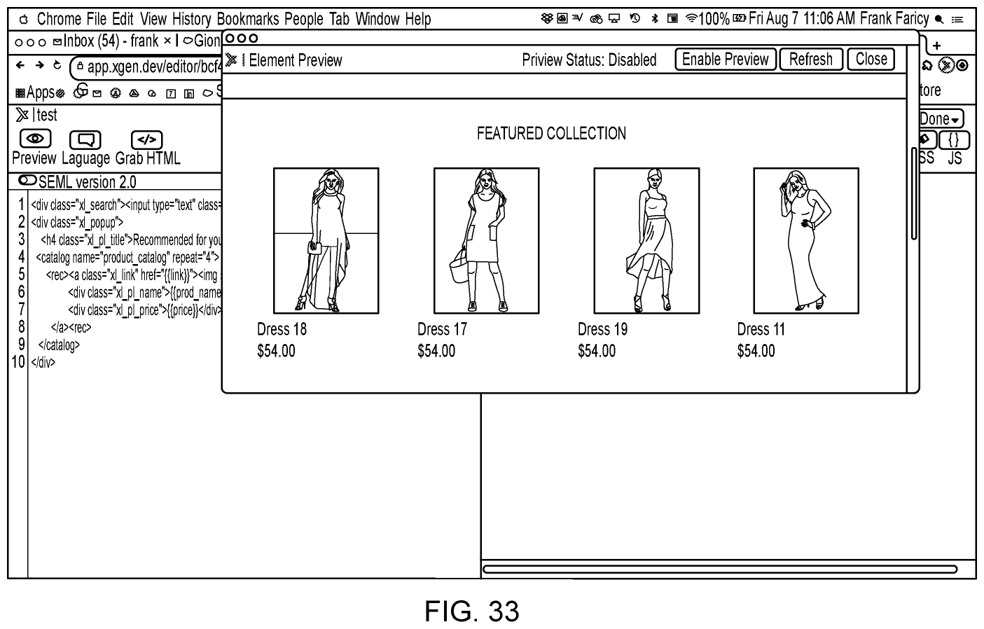

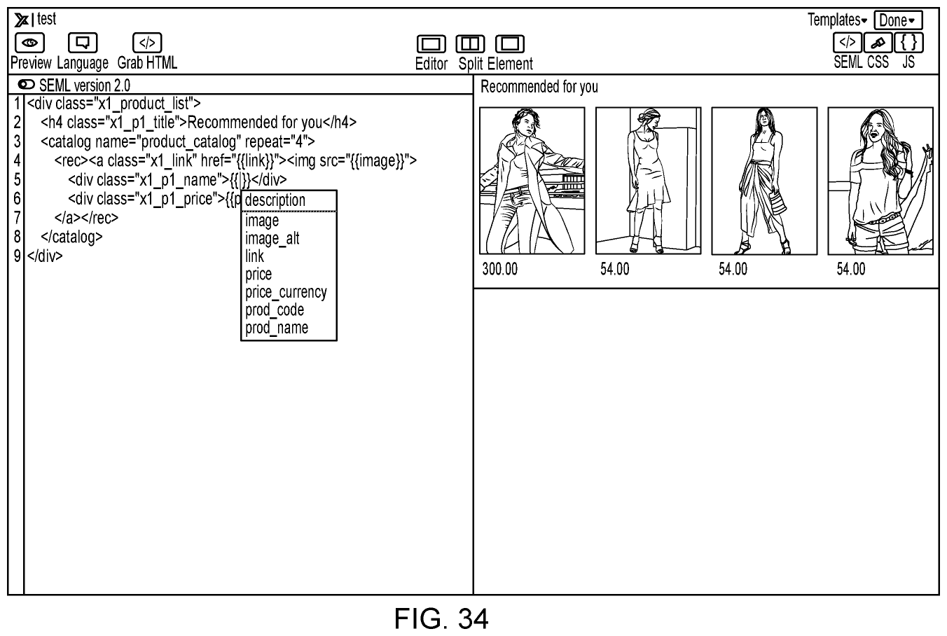

FIGS. 28-34 show examples of various features of the SEML. For example, as show in FIGS. 28-30, an HTML grab tool may be provided for easily grabbing HTML and paste the HTML to the smart editor. FIG. 28 shows that a user may be provided with options 2801 (e.g., “this is a container for products”, “this is a product”, “I want to copy this element as is”, etc.) to deploy a personalization element to a target site. For example, a user may deploy the product to the target site via a container (e.g., by selecting the “this is a container for products” option). The element grabbed by the HTML grab tool may or may not be further modified by the user, and may be deployed to the target site via a smart element container. FIG. 31 shows examples of SEML templates. The preview feature may show the SEML on a target site as shown in FIG. 32 and FIG. 33. This may beneficially allow users to access the SEML smart editor conveniently. FIG. 34 shows an example of the SEML product catalog quick access and populate function.

### Ruleset Creation and Management

As described above, the personalization system allows users to configure the product generated by an AI engine through a ruleset engine. A user may specify a set of rules to modify the predictions generated by a model/AI product or post-processing the results of the recommendation generated by a model. The set of rules may be applied to the AI outputs to further customize the smart element. In some cases, rulesets may be defined as part of the Smart Element definition.

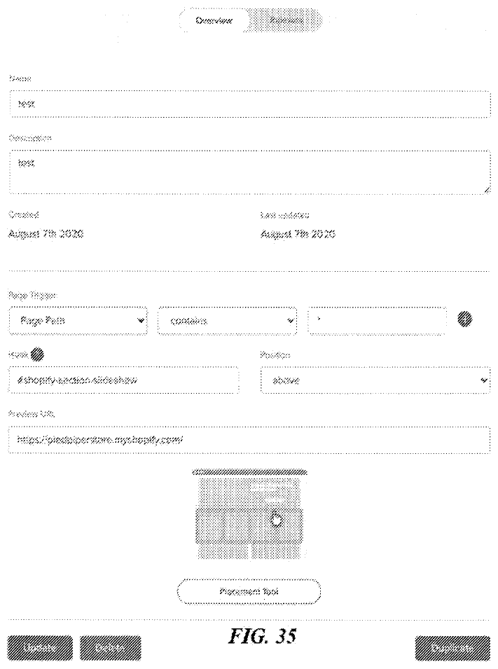

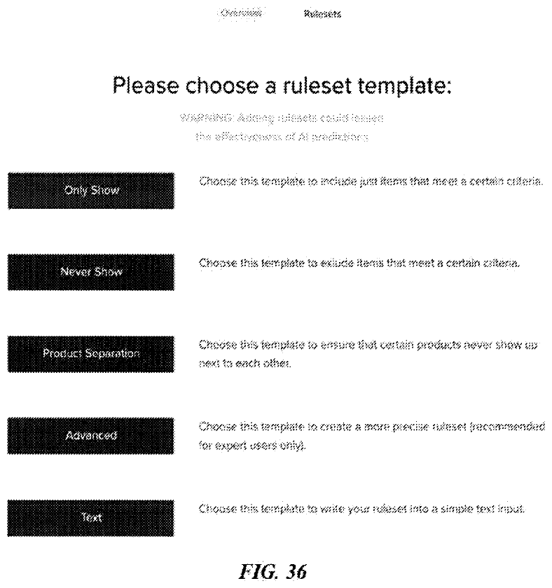

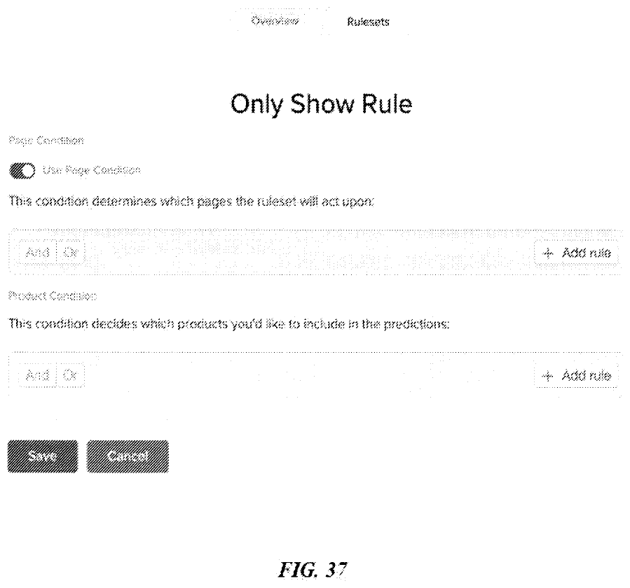

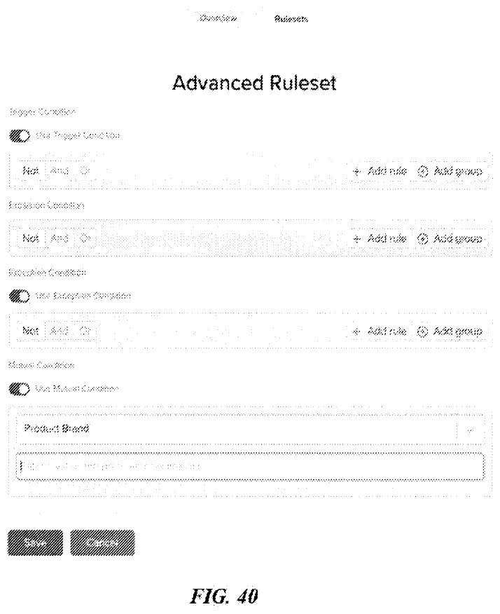

FIGS. 35-41 show examples of GUIs for users to modify and manage the rulesets thereby modifying the AI predictions. As shown in the example of FIG. 36, a user may be permitted to modify or set up the rules by selecting from a ruleset template (e.g., only show, never show, product separation, advanced, text). A user may further modify a selected ruleset template (e.g., only show rule template) by setting page conditions (e.g., conditions determine which pages the ruleset will act on) and/or product conditions (e.g., conditions that decide which products to include in the prediction) as shown in FIG. 37. In some cases, a user may edit the set of rules by adding, deleting a rule, modifying the condition of a rule, and/or logical relationships between rules via the user interface. For instance, a user may add a new rule and specify the logical relationship among the multiple rules via the user interface. As shown in the example, a user may be provided with logical relationship options (e.g., AND, OR) in the user interface to select for adding a rule or adding a group of rules. A user may be allowed to define a rule with options (e.g., mutual conditions, trigger condition, exception condition) as shown in FIG. 40. Upon a user provided input in via the GUI, the system may interpret the rules as a first step about product filtering and a second step about mutual product exclusion. The product filtering may be defined by trigger, exclude and exception attributes. If “trigger condition” is True for a product (triggering the rule), then exclude the product if “exclude condition” is true for it, except the products that satisfy the “exception condition.” The step about mutual product exclusion may be defined by mutual attribute. After applying the first step, if the first product in the list has the attribute “key” and the values is listed in “list”, then filter out every product from the list which has the same key and the value is not in the “list.”

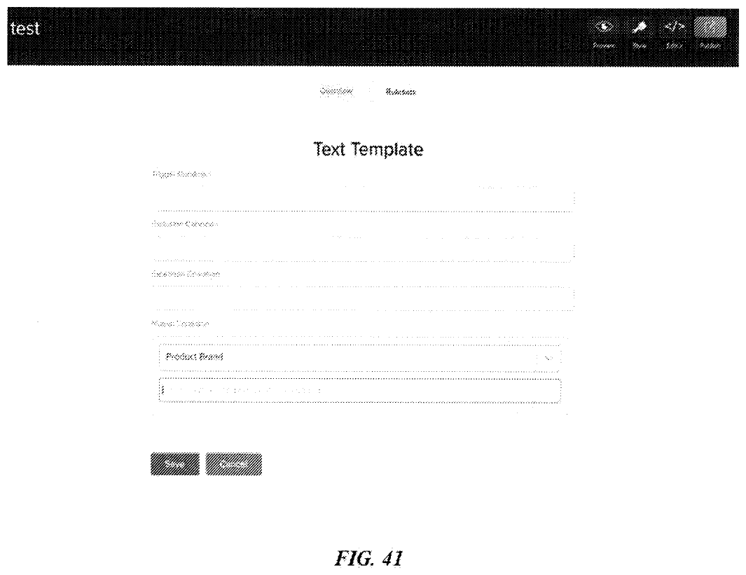

Alternatively or in addition to, the user interface may allow a user to define rules in addition to the system provided options. For example, a user may be allowed to define a rule by a direct input in a text field (e.g., trigger condition, exclusion condition, etc.) as shown in FIG. 41.

As used herein, “or” is inclusive and not exclusive, unless expressly indicated otherwise by context. Therefore, “A or B” means “A, B, or both,” unless expressly indicated otherwise or indicated otherwise by context. Moreover, “and” is both joint and several, unless expressly indicated otherwise or indicated otherwise by context.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A system for automating personalization for a target website comprising:
an artificial intelligence (AI) engine including one or more machine learning algorithm trained models for providing one or more personalization features;
a personalization module configured for integrating the one or more personalization features into the target website; and
a user interface module configured to provide a graphical user interface (GUI) for a user to modify and manage the one or more personalization features.

2. The system of claim 1, wherein at least one of the one or more personalization features is trained for generating recommendations personalized to an individual visitor to the target website.

3. The system of claim 1, wherein the personalization module is configured to further deploy a tracker plugin to the target website for tracking user behaviors on the target website.

4. The system of claim 1, wherein the personalization module is configured to integrate the one or more personalization features by injecting code into the target website.

5. The system of claim 1, wherein the GUI is configured to receive a user input indicating a placement of the one or more personalization features.

6. The system of claim 1, wherein the GUI is configured to receive a user input comprising a selection of an existing element on the target website and a placement of one of the one or more personalization features with respect to the existing element.

7. The system of claim 6, wherein the GUI is configured to display a plurality of placement options for placing the one of the one or more personalization features.

8. The system of claim 1, wherein the GUI is configured to receive a user input indicative of a placement of one of the one or more personalization features and setting a hook for the one of the one or more personalization features.

9. The system of claim 1, wherein the GUI is configured to provide a preview of the one or more personalization features prior to publishing the one or more personalization features to the target website.

10. The system of claim 9, wherein the preview is provided by loading the target website and rendering the one or more personalization features on the loaded target website.

11. The system of claim 1, wherein the GUI is configured to receive a user input defining a ruleset for at least one of the one or more personalization features.

12. The system of claim 11, wherein the ruleset is for modifying a result predicted by the at least one of the one or more personalization features.

13. The system of claim 1, wherein the GUI is further configured to allow the user to adjust a percent of web traffic for the target website to be analyzed by the AI engine.

14. A method for automating personalization for a target website comprising:
generating, with aid of an AI engine, one or more personalization features;
integrating the one or more personalization features into the target website; and
providing a GUI for a user to modify and manage the one or more personalization features.

15. The method of claim 14, wherein at least one of the one or more personalization features is trained for generating recommendations personalized to an individual visiting the target website.

16. The method of claim 14, further comprising deploying a tracker plugin to the target website for tracking user behaviors on the target website.

17. The method of claim 16, further comprising extracting analytics from the tracked user behavior indicating an impact of at least one of the one or more personalization features.

18. The method of claim 14, wherein integrating the one or more personalization features comprises injecting code into the target website.

19. The method of claim 14, further comprising receiving, via the GUI, a user input indicating a placement of the one or more personalization features on the target website.

20. The method of claim 19, wherein the user input comprises a selection of an existing element on the target website and a placement of one of the one or more personalization features with respect to the existing element.
